(19) United States
(12) Patent Application Publication
(10) Pub. No.: US 2026/0202015 A1
(43) Pub. Date: Jul. 16, 2026

(54) WALL FOR A SEALED AND THERMALLY INSULATING TANK

(71) Applicant: GAZTRANSPORT ET TECHNIGAZ, SAINT-REMY-LES-CHEVREUSE (FR)

(72) Inventors: Guillaume SALMON LEGAGNEUR, SAINT-REMY-LES-CHEVREUSE (FR); Bruno DELETRE, SAINT-REMY-LES-CHEVREUSE (FR); Guillaume DE COMBARIEU, SAINT-REMY-LES-CHEVREUSE (FR); Benoît MOREL, SAINT-REMY-LES-CHEVREUSE (FR); Benjamin FAUBRY, SAINT-REMY-LES-CHEVREUSE (FR)

(21) Appl. No.: 19/127,891

(22) PCT Filed: Nov. 10, 2023
(86) PCT No.: PCT/EP2023/081477

§ 371 Date: May 7, 2025

(30) Foreign Application Priority Data
Nov. 15, 2022 (FR) FR2211854

(51) Int. Cl. F17C 3/02; B63B 25/16

(52) U.S. Cl. CPC F17C 3/027; B63B 25/16; F17C 2201/0157; F17C 2203/0358; F17C 2221/012; F17C 2223/0161; F17C 2270/0107

(57) ABSTRACT

The invention relates to a wall (11) comprising an insulating barrier (14) intended to rest against a load-bearing structure and a sealing membrane (15) which rests against the insulating barrier, the insulating barrier comprising: a support element (30) and a modular structure situated between the support element and the sealing membrane, the modular structure being fixed against the support element, the sealing membrane resting against the modular structure and being fixed to said modular structure, the modular structure comprising a first and a second sheet, the sealing membrane comprising a first zone fixed to the first sheet and a second zone fixed to the second sheet, the first sheet being connected to the second sheet by a connection that offers a degree of freedom in translation in a direction perpendicular to the thickness direction of the wall and a degree of connection in the thickness direction of the wall.

### TECHNICAL FIELD

The invention relates to the field of walls of sealed and thermally insulating membrane tanks.

In particular, the invention relates to the field of walls of sealed and thermally insulating tank for storing, transporting and/or using, by way of fuel, low-temperature liquefied gas, such as tanks intended to contain liquid hydrogen which is at around −253° C. at atmospheric pressure. These tanks can be installed onshore or on a floating structure. In the case of a floating structure, the tank can be intended for transporting liquefied gas or for using liquefied gas as a fuel to propel the floating structure.

### TECHNOLOGICAL BACKGROUND

Sealed and thermally insulating tanks for storing a liquefied gas, notably tanks in which the walls exhibit, in succession in the thickness direction of the wall, from the outside to the inside, a load-bearing structure, a thermally insulating barrier and a sealing membrane which rests against the thermally insulating barrier and which is intended to be in contact with the liquefied gas, are known from the prior art.

In this type of tank, the sealing membrane is subjected to high thermal and mechanical stresses, for example when the liquefied gas contained in the tank is being loaded, offloaded and transported, for example as a result of “sloshing” when transported at sea, which sloshing generates waves of liquefied gas that break against the sealed membrane from inside the tank. The stress loadings are the root cause of numerous problems regarding damage to the tank walls.

### SUMMARY

The applicant company has observed that, in a wall of a tank of the above-mentioned type, the sealing membrane is not stressed uniformly. In particular, insofar as the thermally insulating barrier is discontinuous, which is to say made up for example of lagged elements juxtaposed with one another and each supporting a plurality of planar zones of the sealing membrane, its behaviour as the sealing membrane deforms under the effect of the above-mentioned thermal and mechanical stresses is not uniform. Furthermore, hydrodynamic pressures caused by the phenomenon of sloshing are exerted locally in certain planar zones of the sealing membrane and are reacted only by the lagged element or elements supporting said planar zones. Now, notably in order in particular to optimize the life of the sealing membrane and of the thermally insulating barrier, it is important to ensure that the stresses applied thereto are distributed as uniformly as possible. This disadvantage becomes all the more critical when the temperature at which the liquefied gas is stored is low such that the thermal stress is applied to the sealing membrane and the thermally insulating barrier are consequently high.

Moreover, the thermal insulation performance of tanks of the aforementioned type have up to now proven insufficient to allow the storage of a liquefied gas at a very low temperature, such as liquid hydrogen, unless the thickness of the thermally insulating barriers is increased very significantly, something which is not desirable.

One idea underlying the invention is that of addressing the above-mentioned problems.

One idea underlying the invention is that of proposing a sealed and thermally insulating tank wall having a modular structure that allows the loads applied to the tank wall sealing membrane to be distributed as uniformly as possible.

Another idea underlying the invention is that of proposing a wall for a sealed and thermally insulating tank comprising load-bearing elements able to withstand the forces applied transversely to the thickness direction of the wall.

According to one embodiment, the invention provides a wall for a sealed and thermally insulating tank for storing a liquefied gas, the wall comprising in succession, in a thickness direction of the wall, a thermally insulating barrier intended to be anchored, directly or indirectly, on a load-bearing structure and a sealing membrane which rests against the thermally insulating barrier, the thermally insulating barrier comprising:
at least one support element, and
a modular structure situated between the at least one support element and the sealing membrane, the modular structure being fixed against the at least one support element, the sealing membrane resting against the modular structure and being fixed to said modular structure, the modular structure comprising at least a first sheet and a second sheet, the sealing membrane comprising a first zone fixed to the first sheet and a second zone fixed to the second sheet, the first sheet being connected to the second sheet by a connection that offers a degree of freedom in translation in a direction perpendicular to the thickness direction of the wall, so as to allow the sealing membrane to contract, and a degree of connection in the thickness direction of the wall.

By virtue of these features, the first sheet and the second sheet of the modular structure, to which sheets the first zone and the second zone of the sealing membrane are fixed, may effect relative movements in the direction perpendicular to the thickness direction of the wall.

This notably allows the sealing membrane, particularly when it is corrugated, to contract when the tank is cooled and expand as the tank warms up, for example as the tank is emptied. More specifically, when the temperature in the tank drops, the material of which the sealing membrane is made contracts, and to compensate for this, the corrugations of the sealing membrane deploy. What that means is that the corrugations are open wider at a low temperature, for example when the tank is cooled, than at a higher temperature. As the tank warms up again, for example as the tank is emptied, the effect is the opposite.

Furthermore, any deformations of the modular structure in the direction perpendicular to the thickness direction of the wall will be passed on to the sealing membrane only to a small extent.

Furthermore, the connection of the first sheet to the second sheet in the thickness direction of the wall means that the dynamic pressures applied to one of the first and second sheets are also reacted by the other sheet, thereby making it possible to ensure a better distribution of the stresses applied to the wall. This connection also makes it possible to eliminate, or at the very least limit, unevenness or step phenomena between the supporting surfaces that support the sealing membrane, thereby limiting the fatigue stresses to which the sealing membrane is subjected.

According to embodiments, such a wall may comprise one or more of the following features.

According to one embodiment, the connection is formed by direct contact between a lateral portion of the first sheet and a lateral portion of the second sheet. What that means is that the first sheet and the second sheet touch one another without any intermediate component for connecting them.

According to one embodiment, the lateral portion of the first sheet comprises at least a first straight tab and an external tab, these respectively being situated one on each side, in the thickness direction of the wall, of a respective portion of the lateral portion of the second sheet.

According to one embodiment, the lateral portion of the first sheet comprises a second straight tab, the external tab being positioned between the first and second straight tabs and the lateral portion of the second sheet comprises a first external tab, a second external tab and a straight tab positioned between the first external tab and the second external tab of the lateral portion of the second sheet, the first and second straight tabs of the lateral portion of the first sheet extending in a rectilinear fashion and the first and second external tabs of the lateral portion of the second sheet being offset in the thickness direction of the wall and positioned respectively on the outside of the straight tab of the lateral portion of the second sheet, the straight tab of the lateral portion of the second sheet extending in a rectilinear fashion and the external tab of the lateral portion of the first sheet being offset in the thickness direction of the wall and positioned on the outside of the straight tab of the lateral portion of the second sheet.

By virtue of these features, the first sheet is connected directly by contact to the second sheet while at the same time allowing a movement in the direction perpendicular to the thickness direction of the wall. Said movement in the direction perpendicular to the thickness direction of the wall is effected without in any way breaking the connection between the first sheet and the second sheet.

According to one embodiment, the connection formed by direct contact is a trapping of the lateral portion of the first sheet by the lateral portion of the second sheet. That is to say that the first sheet grips the second sheet. This gripping notably makes it possible to maintain direct contact between the first sheet and the second sheet in the presence of thermal and dynamic stress while at the same time allowing movement of the slideway type, in translation in the direction perpendicular to the thickness direction of the wall.

According to one embodiment, the lateral portion of the first sheet engages through interlocking of shapes with the lateral portion of the second sheet and forms an interlock zone.

According to one embodiment, the interlock zone has a through-passage passing in the direction perpendicular to the thickness direction of the wall through the lateral portion of the first sheet and the lateral portion of the second sheet,
the through-passage being formed by at least one opening formed in the lateral portion of the first sheet and corresponding with at least one opening formed in the lateral portion of the second sheet,
a rod being housed in said through-passage so that the first sheet and the second sheet have a degree of connection in the thickness direction of the wall.

According to one embodiment, the rod is straight.

According to one embodiment, the widthwise cross section of the rod has a circular, square, rectangular or oblong shape.

According to one embodiment, the rod is made of metal or of a rigid composite material.

According to one embodiment, the rod has a length long enough to be housed in the at least one opening formed in the lateral portion of the first sheet and in the at least one opening formed in the lateral portion of the second sheet.

According to one embodiment, the rod has a length equal to or greater than the length of the through-passage.

According to one embodiment, the rod has a height chosen so that there is no clearance in the wall-thickness direction between the rod and the through-passage.

According to one embodiment, the rod at one end has an abutment surface in the form of a base so as to hold the rod in the through-passage.

According to one embodiment, the through-passage is formed by a plurality of oblong-shaped openings.

According to one embodiment, the width of the through-passage is less than the width of the rod so as to allow a degree of freedom in translation in a direction perpendicular to the thickness direction of the wall.

According to one embodiment, the lateral portion of the first sheet comprises a tenon projecting towards the second sheet, said tenon being received in a mortise configured in the lateral portion of the second sheet.

According to one embodiment, the lateral portion of the first sheet comprises a second tenon projecting towards the second sheet, said second tenon being received in a second mortise configured in the lateral portion of the second sheet.

According to one embodiment, the lateral portion of the first sheet comprises a third tenon projecting towards the second sheet, said third tenon being received in a third mortise configured in the lateral portion of the second sheet.

According to one embodiment, the first, second and third tenons each have identical or different dimensions that correspond respectively to the first, second and third mortises which each have identical or different dimensions so as to receive the corresponding tenon.

According to one embodiment, the modular structure comprises a third sheet, a fourth sheet and a fifth sheet, the sealing membrane comprising a third zone fixed to the third sheet, a fourth zone fixed to the fourth sheet and a fifth zone fixed to the fifth sheet, the first sheet being connected to the third, fourth and fifth sheets by connections which offer a degree of freedom in translation in a direction perpendicular to the thickness direction of the wall and a degree of connection in the thickness direction of the wall.

According to one embodiment, the first sheet is connected to the third, fourth and fifth sheets via, respectively, a first lateral portion, a second lateral portion, a third lateral portion and a fourth lateral portion of said first sheet.

According to one embodiment, the modular structure comprises a plurality of sheets, for example sixteen sheets, where each of the sheets of the plurality of sheets is at least connected to one other sheet, and preferably each of the sheets is connected to at least two other sheets, for example to three other sheets or four other sheets.

By virtue of these features, the modular structure increases the extent to which the various stresses are spread evenly over the supporting element or elements of the wall. Thus, localized damage to the wall is limited.

According to one embodiment, the modular structure comprises a third sheet, a fourth sheet and a fifth sheet, the sealing membrane comprising a third zone fixed to the third sheet, a fourth zone fixed to the fourth sheet and a fifth zone fixed to the fifth sheet, the first sheet being connected to the second, third, fourth and fifth sheets via, respectively, a first lateral portion, a second lateral portion, a third lateral portion and a fourth lateral portion of said first sheet.

According to one embodiment, the first sheet takes the overall shape of a polygon, for example a quadrilateral, and preferably a square or rectangle. According to one embodiment, each side of the polygon corresponds to a respective lateral portion. For example, in the case of a sheet having the shape of a quadrilateral, the first sheet has a first lateral portion, a second lateral portion, a third lateral portion and a fourth lateral portion.

According to embodiments, the first sheet has the following dimensions:
a length ranging between 20 and 300 centimetres (cm);
a width ranging between 20 and 300 cm;
a thickness ranging between 4 and 30 millimetres (mm).

According to one embodiment, the first sheet is a metal sheet, preferably comprising an alloy of iron and nickel. According to one embodiment, the first sheet is a sheet made of a composite material. According to one embodiment, the composite sheet comprises a metal anchor plate to allow the sealing membrane to be welded to said metal anchor plate.

According to some embodiments, the features that define the first lateral portion of the first sheet may also apply to the other lateral portions of the first sheet, such as the second lateral portion, the third lateral portion and the fourth lateral portion.

According to some embodiments, the features that define the lateral portion of the second sheet may also apply to the other lateral portions of the second sheet.

According to one embodiment, the first sheet has an axis of symmetry. According to one embodiment, the first lateral portion and the fourth lateral portion respectively have an axis of symmetry with the second lateral portion and the third lateral portion. According to one embodiment, the axis of symmetry passes along a diagonal of the first sheet.

According to one embodiment, the first lateral portion, the second lateral portion, the third lateral portion and the fourth lateral portion of the first sheet each have identical or different characteristics.

According to one embodiment, the first sheet is fixed against the at least one support element via a first fixing situated at the centre of the first sheet, and the second sheet is fixed against the at least one support element via a second fixing situated at the centre of the second sheet. The central fixing makes the fixing better balanced.

According to one embodiment, the first fixing and the second fixing are a screw-nut system or a riveted connection.

According to some embodiments, the above-mentioned features of the first sheet apply also to the other sheets of the modular structure, for example to the second sheet, the third sheet, the fourth sheet and/or the fifth sheet.

According to some embodiments, the above-mentioned features of the second sheet apply also to the other sheets of the modular structure, for example to the first sheet, the third sheet, the fourth sheet and/or the fifth sheet.

According to one embodiment, the at least one support element is a thermally insulating panel comprising a layer of self-supporting insulating foam sandwiched between a rigid inner sheet and a rigid outer sheet, the layer of insulating foam preferably being a polymer foam.

According to one embodiment, the modular structure is fixed to the rigid inner sheet.

According to one embodiment, the rigid inner sheet is equipped with metal anchor plates intended for anchoring the modular structure.

According to one embodiment, the at least one support element is an insulating box structure comprising a bottom sheet, a top sheet and load-bearing webs extending, in the thickness direction of the wall, between the bottom sheet and the top sheet and delimiting at least one compartment filled with a thermally insulating packing. Such an insulating box structure is described for example in document WO2012127141.

According to one embodiment, the thermally insulating packing is selected from: perlite, glass wool and rock wool.

According to one embodiment, the at least one support element comprises a layer of flexible material in contact with the modular structure.

According to one embodiment, the flexible material has a Young's modulus in compression in the thickness direction of the tank wall that ranges between 0.25 and 25 MPa, and is for example made of felt.

According to one embodiment, the flexible material has a compressive Young's modulus that is lower than the Young's modulus of the layer of self-supporting insulating foam of the thermally insulating panel. What that means to say is that the flexible material is more flexible than said layer of self-supporting insulating foam of the thermally insulating panel.

According to one embodiment, the ratio between the compressive Young's modulus of the flexible material and the compressive Young's modulus of said layer of self-supporting insulating foam of the thermally insulating panel is less than or equal to 1/5, and preferably comprised between ⅕ and 1/20.

According to one embodiment, the flexible material has a compressive Young's modulus that is lower than the Young's modulus of the material, such as plywood, from which at least one of the bottom sheet, the top sheet and the load-bearing webs of the insulating box structure is or are made.

According to one embodiment, the ratio between the compressive Young's modulus of the flexible material and the compressive Young's modulus of said material from which at least one of the bottom sheet, the top sheet and the load-bearing webs of the insulating box structure is or are made is less than or equal to 1/5, and preferably comprised between ⅕ and 1/20.

According to one embodiment, the layer of flexible material extends in the direction perpendicular to the thickness direction of the wall.

According to one embodiment, the thermally insulating barrier comprises a first support element and a second support element, the first support element being a first post and the second support element being a second post, the first post and the second post extending in the thickness direction of the wall, the first post being fixed to the first sheet and the second post being fixed to the second sheet.

According to one embodiment, the modular structure comprises:
a first sleeve fixed between an inner end of the first post and the first sheet, a second sleeve fixed between an inner end of the second post and the second sheet, and
a metal girder connecting the first sleeve and the second sleeve by way of a sliding joint offering sliding in the direction perpendicular to the thickness direction of the wall.

According to one embodiment, the metal girder has a rectilinear shape. According to one embodiment, the metal girder has the form of a rectangular parallelepiped.

According to one embodiment, the sleeve has a cylindrical or cubic shape.

According to one embodiment, the sleeve has a through-slot, preferably in the shape of a cross.

According to one embodiment, the thermally insulating barrier comprises a third support element, the third support element being a third post extending in the thickness direction of the wall, wherein the first post, the second post and the third post are aligned.

According to one embodiment, the modular structure comprises a third sheet and a third sleeve which is fixed between an inner end of the third post and the third sheet, the sealing membrane comprising a third zone fixed to the third sheet, wherein the metal girder connects the third sleeve.

According to one embodiment, each sleeve is fixed by push-fitting into the inner end of the post. According to an embodiment variant, each sleeve is fixed by push-fitting onto the outside of the inner end of the post. The inner end of the post is that end of the post that is closest to the sealing membrane intended to be in contact with the liquefied gas contained in the tank.

According to one embodiment, the first sleeve and the second sleeve have a through-opening in the direction perpendicular to the thickness direction of the wall so as to receive the metal girder.

According to one embodiment, the third sleeve has a through-opening in the direction perpendicular to the thickness direction of the wall so as to receive the metal girder.

According to one embodiment, the modular structure comprises a metal girder connecting the first sheet and the second sheet by way of a sliding joint offering sliding in the direction perpendicular to the thickness direction of the wall.

According to one embodiment, the metal girder has an I-shaped cross section. In other words, the girder is an I-section girder also known as a standard I-girder.

According to one embodiment, the I-section girder has a first and a second lateral channel, these channels extending in the longitudinal direction of the girder, the first lateral channel receiving a lateral portion of the first sheet and the second lateral channel receiving a lateral portion of the second sheet.

Thus, the I-section girder prevents the first sheet and the second sheet from rotating about axes parallel to the thickness direction of the wall. As a result, the surface of the modular structure at the first and second sheets is planar and rigid.

According to one embodiment, the first lateral channel and the second lateral channel of the girder each receive a plurality of lateral portions of sheets of the modular structure.

According to one embodiment, each post is made from a composite material comprising fibres and a matrix, making it possible to achieve satisfactory compressive strength for a limited conducting cross section.

According to one embodiment, the fibres are selected from glass fibres, carbon fibres, aramid fibres, flax fibres, basalt fibres and blends thereof.

According to one embodiment, the matrix is selected from polyethylene, polypropylene, poly(ethylene terephthalate), polyamide, polyoxymethylene, polyetherimide, polyacrylate, polyaryl ether ketone, polyether ether ketone, copolymers thereof, polyester, vinylester, epoxy and polyurethane.

According to one preferred embodiment, the posts are made from a glass fibre reinforced epoxy resin.

According to one embodiment, each post has a tubular section.

According to one embodiment, each post has one or more through-orifices opening into an internal space of said post.

According to one embodiment, each post has an internal space which is filled with insulating packing made of an open-cell porous material, for example selected from an open-cell insulating polymer foam, such as open-cell polyurethane foam, glass wool, rock wool, melamine foam, polyester wadding, polymer aerogels such as polyurethane-based aerogel, notably the one marketed under the trade name Slentite®, and silica aerogels.

According to one embodiment, the first sheet is connected to an inner end of the first post via a connecting device which holds the first sheet on the first post in the thickness direction,

the connecting device offering:
a degree of freedom to rotate about a first axis which is perpendicular to the thickness direction of the wall, and
a degree of freedom to rotate about a second axis which is perpendicular to the thickness direction of the wall and orthogonal to the first axis.

By virtue of these features, the connection, made by the connecting device, between the sealing membrane and the post allows these elements some relative movement and thus forms an absorber device that attenuates the loads liable to be transmitted to the post, notably when the sealing membrane is subjected to the phenomenon of sloshing. The bending moments applied to the post are thus reduced. The life of the support element and therefore of the tank wall is thus increased by comparison with a tank wall that does not have the above-mentioned features.

According to one embodiment, the second sheet is connected to an inner end of the second post via a second connecting device which holds the second sheet on the second post in the thickness direction,

the second connecting device offering:
a degree of freedom to rotate about a first axis which is perpendicular to the thickness direction of the wall, and
a degree of freedom to rotate about a second axis which is perpendicular to the thickness direction of the wall and orthogonal to the first axis.

According to one embodiment, the connecting device offers:
a degree of freedom in translation along the first axis, and
a degree of freedom in translation along the second axis.

According to one embodiment of the wall, the connecting device offers a degree of freedom to rotate in the thickness direction of the wall.

According to one embodiment of the wall, the connecting device offers a degree of freedom in translation in the thickness direction which is limited to a translational movement by a determined maximum distance, preferably a distance of less than 3 cm.

According to one embodiment, the connecting device comprises a support fixed to the inner end of the first post.

According to one embodiment, the support comprises a sleeve which is push-fitted onto or into the inner end of the post.

According to one embodiment, the sleeve is fixed against a longitudinal surface of the post.

According to one embodiment, the sleeve extends beyond the inner end of the post.

According to one embodiment, the post is hollow.

According to one embodiment, the sealing membrane is welded to the first metal sheet.

According to one embodiment, the support comprises a blanking plate fixed to the inner end of the first post and covering the inner end of the first post.

According to one embodiment, the blanking plate is made of metal.

According to one embodiment, the connecting device comprises a ball-joint ball seat and a ball-joint ball element housed in said ball seat, of the ball seat and the ball element one being secured to the first sheet and the other to the support.

The “ball element” and “ball seat” of a ball joint are respectively defined, within the meaning of the present text, as being the protruding element and the receiving socket of a ball joint connection.

According to one embodiment, the connecting device is arranged in such a way as to press the ball-joint ball element and the ball-joint ball seat against one another.

According to one embodiment, the connecting device comprises a rod passing through the ball element and the ball seat of the ball joint.

According to one embodiment, the rod of the connecting device has a first end fixed to one of either the support or the first sheet.

According to one embodiment, said rod of the connecting device has a second end fixed to the other of either the support or the first sheet.

According to one embodiment, said rod of the connecting device has a first end equipped with an abutment surface.

According to one embodiment, said rod of the connecting device has a second end equipped with an abutment surface.

According to one embodiment, the connecting device further comprises at least one elastic member or spherical washer mounted on the rod and positioned between the abutment surface and one of either the ball seat or the ball element so as to press the ball element and the ball seat against one another.

According to one embodiment, the connecting device comprises an elastic member or spherical washer mounted on the rod and positioned between the abutment surface and the ball seat and further comprises an elastic member or spherical washer mounted on the road and positioned between the abutment surface and the ball element, so as to press the ball element and the ball seat against one another.

According to one embodiment, said rod of the connecting device has a first end fixed to one of the elements that are the support and the first sheet and a second end equipped with an abutment surface, the connecting device further comprising at least one elastic member or spherical washer mounted on the rod and positioned between the abutment surface and one of either the ball seat or the ball element so as to press the ball element and the ball seat against one another.

According to one embodiment, the connecting device comprises a rod having a first end which is fixed to a first of the elements that are the first sheet and the support, and a second end comprising an abutment surface, said rod passing through a second of the elements that are the first sheet and the support, the connecting device further comprising at least one elastic member or spherical washer mounted on the rod and positioned between the first sheet and the support so as to press the second element against the abutment surface.

According to one embodiment of the wall, the elastic member is dimensioned in such a way as to limit the freedom to effect a translational movement in the thickness direction.

According to one embodiment, the elastic member comprises a Belleville spring washer.

According to one embodiment, the elastic member comprises a plurality of Belleville spring washers, preferably 2 or 3 Belleville spring washers.

According to one embodiment, the rod is a screw comprising a screw head and the abutment surface is the screw head.

According to one embodiment, the connecting device comprises a plurality of rods spaced apart from one another and a plurality of elastic members, each rod having a first end which is fixed to a first of the elements that are the first sheet and the support, and a second end comprising an abutment surface, said rod passing through a second of the elements that are the first sheet and the support, each elastic member mounted on one of the rods and positioned between the first sheet and the support so as to press the second element against the abutment surface.

According to one embodiment, the plurality of rods comprises three rods distributed in such a way that the three segments of straight lines connecting the rods pairwise form an equilateral triangle.

According to one embodiment, the abutment surface is positioned in a counterbore formed in the ball element or in the ball seat, the elastic member or spherical washer being positioned in the counterbore between the screw head and a bottom end of the counterbore.

According to one embodiment, the support element comprises:
an outer plate which is connected to an outer end of the first post via an outer connecting device which holds the outer plate on the first post in the thickness direction, the secondary sealing membrane being fixed to the outer plate,
the outer connecting device offering:
a degree of freedom to rotate about a first axis which is perpendicular to the thickness direction of the wall, and
a degree of freedom to rotate about a second axis which is perpendicular to the thickness direction of the wall and orthogonal to the first axis.

According to some embodiments, the outer connecting device is analogous with the connecting device, which is to say may comprise one or more of the features of the connecting device positioned at the outer end of the first post. For example, according to one embodiment, the outer connecting device comprises a support fixed to the outer end of the first post and comprises a ball-joint ball seat and a ball element housed in said ball seat, of the ball seat and the ball element one being secured to the outer plate and the other to the support.

According to one embodiment, the outer plate is made of metal.

According to one embodiment, the secondary sealing membrane is welded to the outer metal plate.

According to one embodiment, the secondary thermally insulating barrier comprises the support element.

According to one embodiment, the secondary thermally insulating barrier comprises a plurality of support elements.

According to one embodiment, the primary thermally insulating barrier comprises the aforementioned support element.

According to one embodiment, the primary thermally insulating barrier comprises a plurality of support elements.

According to one embodiment, the secondary thermally insulating barrier and the primary thermally insulating barrier each comprise the support element. According to one embodiment, the primary thermally insulating barrier and the secondary thermally insulating barrier comprise a plurality of support elements.

According to one embodiment, the primary sealing membrane comprises a first series of corrugations having first corrugations parallel to one another and a second series of corrugations having second corrugations parallel to one another and perpendicular to the first corrugations, the primary sealing membrane comprising a plurality of planar zones each of which is defined between two adjacent first corrugations and between two adjacent second corrugations,
the plurality of planar zones of the primary sealing membrane comprising a first planar zone which is welded against the first sheet of the support element.

According to one embodiment, the secondary sealing membrane comprises a first series of corrugations having first corrugations parallel to one another and a second series of corrugations having second corrugations parallel to one another and perpendicular to the first corrugations, the secondary sealing membrane comprising a plurality of planar zones each of which is defined between two adjacent first corrugations and between two adjacent second corrugations,
the plurality of planar zones of the secondary sealing membrane comprising a first planar zone which is welded against the outer plate of the support element.

According to one embodiment, the invention also provides a sealed and thermally insulating tank comprising at least a first and a second wall like the above-mentioned walls.

According to one embodiment of the tank, the first wall and the second wall form a corner of the tank, and the first wall and the second wall each comprise a row of support elements supporting the sealing membrane which extends parallel to the corner edge and the row comprises the support element.

According to one embodiment of the tank, the first wall and the second wall comprise:
a first row of support elements supporting the sealing membrane, which row extends parallel to the corner edge and is situated close to the corner of the tank, and
a second row of support elements supporting the sealing membrane, which row extends parallel to the corner edge and is adjacent to the first row, this second row comprising the support element.

According to one embodiment, the sealing membrane is a corrugated sealing membrane comprising a first series of corrugations having first corrugations parallel to one another and a second series of corrugations having second corrugations parallel to one another and perpendicular to the first corrugations, the sealing membrane comprising a plurality of planar zones each of which is defined between two adjacent first corrugations and between two adjacent second corrugations,
the first zone and the second zone corresponding to two adjacent planar zones.

By virtue of these features, the stresses experienced by the corrugated sealing membrane are uniformly distributed between the corrugations of this membrane.

According to one embodiment, the primary thermally insulating barrier comprises at least a first row of posts comprising, in succession in a direction parallel to the first corrugations, at least the first, the second and the third posts which are fixed to the secondary thermally insulating barrier and extend in the thickness direction of the wall, the first, the second and the third posts being respectively fixed to the first, to the second and to the third sheets, the first, the second and the third posts being respectively situated in a planar zone.

These features allow good distribution of the stresses between the corrugations of the sealing membrane.

According to one embodiment, the primary thermally insulating barrier comprises at least a second row of posts comprising a fourth, a fifth and a sixth post which posts are fixed to the secondary thermally insulating barrier and extend in the thickness direction of the wall, the fourth, the fifth and the sixth posts being aligned in a direction parallel to the second corrugations and being respectively fixed to a fourth, a fifth and a sixth sheet, the fourth, the fifth and the sixth posts being respectively situated in a planar zone.

Thus, the primary thermally insulating barrier comprises both support elements which are aligned parallel to the first corrugations of the primary sealing membrane, and support elements which are aligned parallel to the second corrugations of the primary sealing membrane.

According to one embodiment, the sealing membrane is fixed to the modular structure by welding.

According to one embodiment, the thermally insulating barrier is a primary thermally insulating barrier and the sealing membrane is a primary sealing membrane which is intended to come into contact with the liquefied gas contained in the tank, the wall comprising a secondary thermally insulating barrier intended to rest against the load-bearing structure, a secondary sealing membrane which rests against the secondary thermally insulating barrier, the primary thermally insulating barrier resting against the secondary sealing membrane and the primary sealing membrane resting against the primary thermally insulating barrier.

According to one embodiment, the secondary thermally insulating barrier rests against the load-bearing structure.

According to another embodiment, the first series of corrugations and the second series of corrugations of the secondary sealing membrane project towards the inside, in the direction away from the load-bearing structure.

According to one embodiment, the primary thermally insulating barrier has a gas phase kept at a vacuum pressure with respect to atmospheric pressure.

By virtue of these features, the thermal insulation properties of the primary thermally insulating barrier are enhanced.

According to one embodiment, the gas phase is placed at an absolute pressure of below 1 Pa, advantageously below 101 Pa, preferably below 102 Pa and for example of the order of 10-3 Pa. This makes it possible to enhance the thermal insulation performance of the primary thermally insulating barrier.

According to one embodiment, the secondary thermally insulating barrier has a gas phase under vacuum, preferably at an absolute pressure lower than 1 Pa.

According to one embodiment, the primary sealing membrane comprises a plurality of corrugated metal sheets, each corrugated metal sheet having edges which are each lap welded to an edge of an adjacent corrugated metal sheet.

According to one embodiment, the secondary thermally insulating barrier comprises insulating panels which are anchored to the load-bearing structure. According to one embodiment, the insulating panels are made from: glass wool, rock wool, polyester wadding, open-cell polymer foams, such as open-cell polyurethane foams, or melamine foams.

According to one embodiment, each insulating panel comprises a layer of insulating polymer foam sandwiched between an inner sheet and an outer sheet, for example made of plywood or made from a fibre-reinforced, such as glass-fibre-reinforced, polymer matrix.

According to one embodiment, the inner sheet of the insulating panels is equipped with a metal anchor plates intended for anchoring the modular structure on the insulating panels, and/or for anchoring the sealing membrane on the insulating panels.

According to one embodiment, the inner sheet of the insulating panels is equipped with metal anchor plates intended for anchoring the edges of the corrugated metal sheets of the secondary sealing membrane on the insulating panels.

According to one embodiment, the liquefied gas is hydrogen.

The invention also provides a sealed and thermally insulating tank comprising a plurality of above-mentioned walls.

According to one embodiment, the sealed and thermally insulating tank contains liquefied hydrogen.

The tank may be produced using various techniques, notably in the form of an integrated membrane tank. For example, the tank is a polyhedral tank.

Such a tank may form part of an onshore storage facility, or be installed in a floating, inshore or offshore structure, in particular a ship for transporting liquid hydrogen, which is to say a hydrogen tanker, a floating storage and regasification unit (FSRU), a floating production storage and offloading (FPSO) unit, and the like. Such a tank can also be used as a fuel tank on any type of ship.

According to one embodiment, a tanker ship for the transportation of a liquefied gas comprises a double hull and an abovementioned tank arranged in the double hull.

According to one embodiment, the invention also provides a transfer system for transferring a liquefied gas, the system including the above-mentioned ship, insulated pipelines arranged so as to connect the sealed and thermally insulating tank installed in the ship's hull to a floating or on-shore storage facility, and a pump for driving a flow of liquefied gas through the insulated pipelines from or to the floating or on-shore storage facility to or from the sealed and thermally insulating tank of the ship.

According to one embodiment, the invention also provides a process for loading or emptying such a ship, in which combustible gas is conducted through insulated pipelines from or to a floating or on-shore storage facility to or from the ship's leaktight heat-insulating tank.

### BRIEF DESCRIPTION OF THE FIGURES

The invention will be better understood, and further aims, details, features and advantages thereof will become more clearly apparent in the course of the following description of a number of particular embodiments of the invention, which are given solely by way of illustration and without limitation, with reference to the appended drawings.

FIG. 1 is a schematic and perspective view, with cutaway, of a load-bearing structure intended to support a sealed and thermally insulating tank for storing a liquefied gas.

FIG. 2 is a partial and perspective view of a wall of a sealed and thermally insulating tank according to a first embodiment.

FIG. 3 is an enlarged view, in cross section, of region III of FIG. 2.

FIG. 4 is a perspective view of a sheet of a modular structure according to one embodiment.

FIG. 5 is a perspective view of a modular structure formed of four sheets connected to one another according to the embodiment of FIG. 4.

FIG. 6 is a perspective view of a wall according to another embodiment comprising a modular structure.

FIG. 7 is a perspective view of a modular structure according to another embodiment.

FIG. 8 is a perspective view of a sheet of the modular structure of FIG. 7.

FIG. 9 is a perspective view of a connection of a first sheet to a second sheet of the modular structure of FIG. 7.

FIG. 10 is a schematic, partial and perspective view of a wall comprising a modular structure according to another embodiment.

FIG. 11 is a schematic, partial and perspective view of a wall comprising a modular structure according to another embodiment.

FIG. 12 is a schematic cut-away depiction of a ship's tank for transporting liquefied gas and of a terminal for loading/offloading from this tank.

FIG. 13 is a partially exploded perspective view of a modular structure according to another embodiment.

FIG. 14 is an enlarged perspective view of the modular structure of FIG. 13.

FIG. 15 depicts a schematic, partial, sectioned view of a first variant of a first embodiment of the connecting device that connects the modular structure to the post, the connection between the first sheet and the second sheet having been deliberately omitted.

FIG. 16 depicts a schematic, partial, sectioned view of a second variant of the first embodiment of the connecting device that connects the modular structure to the post, the connection between the first sheet and the second sheet having been deliberately omitted.

FIG. 17 depicts a partial perspective view of the second variant, depicted in FIG. 3, of the connecting device that connects the modular structure to the post.

FIG. 18 depicts a schematic, partial, sectioned view of a third variant of the first embodiment of the connecting device that connects the modular structure to the post, the connection between the first sheet and the second sheet having been deliberately omitted.

FIG. 19 depicts a schematic, partial, sectioned view of a first variant of a second embodiment of the connecting device that connects the modular structure to the post, the connection between the first sheet and the second sheet having been deliberately omitted.

FIG. 20 depicts a schematic, partial, sectioned view of a second variant of the second embodiment of the connecting device that connects the modular structure to the post, the connection between the first sheet and the second sheet having been deliberately omitted.

FIG. 21 depicts a schematic, partial, sectioned view of a third variant of the second embodiment of the connecting device that connects the modular structure to the post, the connection between the first sheet and the second sheet having been deliberately omitted.

FIG. 22 depicts a schematic, partial, sectioned view of a fourth variant of the second embodiment of the connecting device that connects the modular structure to the post, the connection between the first sheet and the second sheet having been deliberately omitted.

FIG. 23 depicts a schematic, partial, sectioned view of a third embodiment of the connecting device that connects the modular structure to the post, the connection between the first sheet and the second sheet having been deliberately omitted.

FIG. 24 depicts a partial sectioned view of a corner of a sealed and thermally insulating tank for storing a liquefied gas, according to one embodiment, the connection between the first sheet and the second sheet having been deliberately omitted.

FIG. 25 is a schematic, partial, sectioned view of a wall comprising a modular structure according to another embodiment.

FIG. 26 is a schematic, partial, perspective view of a wall comprising the modular structure according to the embodiment of FIG. 25, the sealing membrane having been deliberately omitted.

### DESCRIPTION OF THE EMBODIMENTS

By convention, the terms “outer” and “inner” are used to define the relative position of one element relative to another, with reference to the inside and outside of the tank.

The liquefied gas intended to be stored in the tank may notably be liquid hydrogen which has the particular feature of being stored at approximately −253° C. at atmospheric pressure. Nevertheless, it may be noted that the invention applies to any other liquefied gas, for example liquefied natural gas.

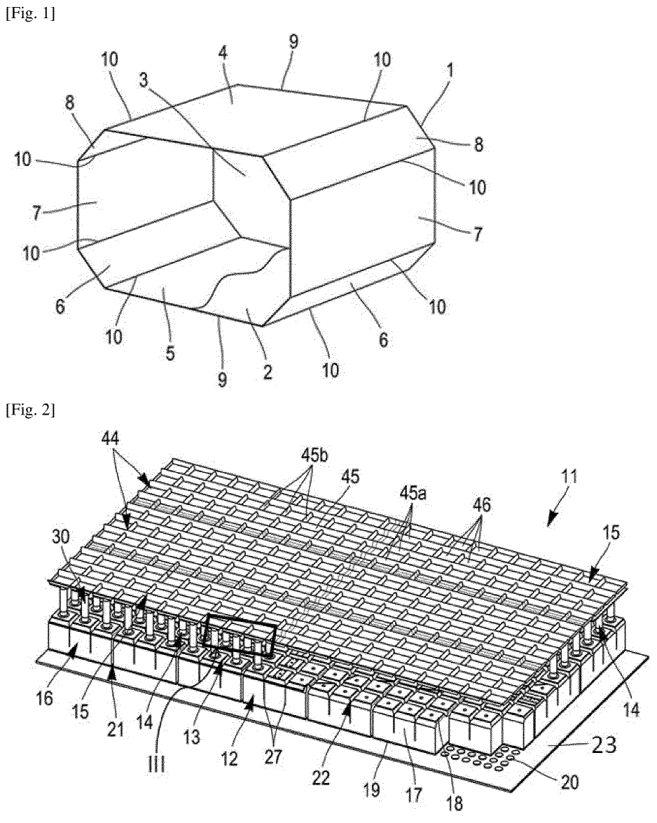

Reference is made to FIG. 1 which shows a tank 1 intended to receive a liquefied gas.

The tank 1 comprises a load-bearing structure formed by the inner hull (not depicted) of a double-hulled ship (not depicted). The tank 1 has a polyhedral or prismatic overall shape. The tank 1 has a first transverse wall 2 and a second transverse wall 3, in this instance of octagonal shape. In FIG. 1, the first transverse wall 2 has been depicted only in part, making the internal space inside the tank 1 visible. The tank 1 also comprises a roof wall 4, a bottom wall 5, lower angled walls 6, lateral walls 7 and upper angled walls 8. The roof wall 4, the bottom wall 5, the lower angled walls 6, the lateral walls 7 and the upper angled walls 8 extend in the longitudinal direction of the ship, connect the first and second transverse walls 2, 3 at transverse corner edges 9, and meet at longitudinal corner edges 10.

Each wall of the tank exhibits, in succession, in a thickness direction of the wall, a thermally insulating barrier intended to rest against a load-bearing structure and a sealing membrane which rests against the thermally insulating barrier.

In general, each wall of the tank has a multilayer structure comprising, from the outside towards the inside of the tank, a secondary thermally insulating barrier comprising a plurality of secondary insulating panels, which barrier is intended to be anchored, directly or indirectly, to a load-bearing structure, a secondary sealing membrane resting against the secondary thermally insulating barrier, a primary thermally insulating barrier comprising a plurality of primary insulating panels or a plurality of primary posts, resting against the secondary sealing membrane, and a primary sealing membrane intended to be in contact with the liquefied gas contained in the tank. The primary sealing membrane defines an internal space intended to contain the liquefied gas, such as liquid hydrogen.

Walls for a sealed and thermally insulating tank for storing a liquefied gas according to some embodiments will be described more particularly hereinbelow in connection with FIGS. 2 to 11.

The wall 11 for a sealed and thermally insulating tank for storing a liquefied gas has a multilayer structure comprising, in the thickness direction of the wall 11, from the outside towards the inside, a secondary thermally insulating barrier 12 intended to rest against a load-bearing structure 23, a secondary sealing membrane 13, a primary thermally insulating barrier 14, and a primary sealing membrane 15 intended to be in contact with the liquefied gas contained in the tank.

The secondary thermally insulating barrier 12 comprises a plurality of insulating panels 16 which are anchored to the load-bearing structure 23. The insulating panels 16 each have a layer 17 of insulating polymer foam layer sandwiched between an inner sheet 18 and an outer sheet 19. The inner sheet 18 and outer sheet 19 are, for example, sheets of plywood adhesively bonded to said layer 17 of insulating polymer foam. In a variant, the inner sheets 18 and outer sheets 19 are made from a fibre-reinforced, such as glass-fibre-reinforced, polymer matrix. The insulating polymer foam may notably be a polyurethane-based foam. The polymer foam is advantageously reinforced with fibres, such as glass fibres, which contribute to reducing its thermal contraction.

The insulating panels 16 are anchored to the load-bearing structure 23 by means of secondary anchoring devices, not depicted. Each insulating panel 16 is, for example, fixed at least at each of its four corners. Each secondary anchoring device comprises a stud welded to the load-bearing structure 23 as well as a pressing member which is fixed to the stud and which presses against a bearing zone of the insulating panels 16. According to one embodiment, the outer sheet 19 of the insulating panels 16 extends beyond the layer 17 of insulating polymer foam at least at the corners of the insulating panel 16 so as to form the bearing zones of the insulating panels 16 that collaborate with the pressing members of the secondary anchoring devices. Elastic members, such as Belleville spring washers, are advantageously slipped onto the stud, between a nut mounted on the stud and the pressing member, enabling the insulating panels 16 to be anchored elastically on the load-bearing structure 23.

Advantageously, lengths of mastic 20 are interposed between the outer sheet 19 of the insulating panels 16 and the load-bearing structure 23. The lengths of mastic 20 thus contribute towards compensating for surface irregularities of the load-bearing structure 23. According to one advantageous embodiment variant, the lengths of mastic 20 adhere to the outer sheet 19 of the insulating panels 16 and to the load-bearing structure 23. The lengths of mastic 20 thus contribute towards anchoring the insulating panels 16 on the load-bearing structure 23. In such an embodiment variant, the secondary anchoring devices are optional.

The insulating panels 16 are substantially in the shape of a rectangular parallelepiped and are juxtaposed in parallel rows separated from one another by gaps 21 ensuring a functional mounting clearance. The gaps 21 are filled with an insulating packing, not depicted, such as glass wool, rock wool or open-cell flexible synthetic foam for example. The gaps may also be filled with insulating plugs, as described in applications WO2019155157 or WO2021028624, for example.

In the embodiment depicted, the inner face of the insulating panels 16 exhibits two series of channels 22 perpendicular to one another and intended to receive corrugations, projecting towards the outside of the tank, formed on the corrugated metal sheets of the secondary sealing membrane 13. Each of the series of channels 22 is parallel to two opposite sides of the insulating panels 16. In the embodiment depicted, the channels 22 pass through the full thickness of the inner sheet 18 and into an inner portion of the layer 17 of insulating polymer foam. Advantageously, the channels 22 have a shape that complements that of the corrugations of the secondary sealing membrane 13.

Moreover, the inner sheet 18 of the insulating panels 16 is equipped with metal anchor plates intended for anchoring the edges of the corrugated metal sheets of the secondary sealing membrane 13 on the insulating panels 16. The metal anchor plates extend in two perpendicular directions each of which is parallel to two opposite sides of the insulating panels 16. The metal anchor plates are fixed to the inner sheet 18 of the insulating panels 16 by screws, rivets, or staples, for example. The metal anchor plates are fitted into recesses formed in the inner sheet 18 in such a way that the inner surface of the metal anchor plates lies flush with the inner surface of the inner sheet 18.

Moreover, the insulating panels 16 have relaxation slits 27 that reduce their stiffness so that the secondary thermally insulating barrier 12 can deform as evenly as possible. This makes it possible to obtain the most uniform possible deformations of the corrugations of the secondary sealing membrane 13. Advantageously, the insulating panels 16 have relaxation slits 27 at least facing each of the corrugations 24 of the secondary sealing membrane 13. Thus, a relaxation slit 27 extends from the bottom of each of the channels 22 towards the outer sheet 19 of the insulating panels 16. According to an optional variant, the insulating units 16 also comprise relaxation slits which open onto the outer face of the insulating panels 16. Such relaxation slits are therefore not positioned facing a corrugation of the secondary sealing membrane 13 but midway between two parallel corrugations of the secondary sealing membrane 13.

The secondary sealing membrane 13 comprises a plurality of corrugated metal sheets each of substantially rectangular shape. The corrugated metal sheets are, for example, made of Invar®: namely an alloy of iron and of nickel the coefficient of expansion of which is typically comprised between 1.2×10⁻⁶ and 2×10⁻⁶ K⁻¹ , or from an iron alloy with a high manganese content the coefficient of expansion of which is typically of the order of 7×10⁶ K⁻¹. Alternatively, the corrugated metal sheets may equally be made of stainless steel or of aluminium.

The corrugated metal sheets are lap welded along their edges so as to ensure the fluidtightness of the secondary sealing membrane 13. Moreover, the corrugated metal sheets are arranged in an offset manner relative to the insulating panels 16 of the secondary thermally insulating barrier 12 such that each of said corrugated metal sheets extends concomitantly over several adjacent insulating panels 16. In order to anchor the secondary sealing membrane 13 on the secondary thermally insulating barrier 12, the edges of the corrugated metal sheets are welded to the metal anchor plates, for example using spot welding.

The secondary sealing membrane 13 has corrugations and, more particularly, a first series of corrugations extending parallel to a first direction and a second series of corrugations extending parallel to a second direction. The directions of the series of corrugations are mutually perpendicular. Each of the series of corrugations is parallel to two opposite edges of the corrugated metal sheet. The corrugations here project towards the outside of the tank, i.e. towards the load-bearing structure 23. The secondary sealing membrane 13 comprises, between the corrugations, a plurality of planar zones.

The corrugations of the secondary sealing membrane 13 are housed in the channels 22 formed in the inner face of the insulating panels 16 and in the gaps 21 formed between adjacent insulating panels 16.

Moreover, the planar zones of the secondary sealing membrane 13 each have passing through them a primary anchoring device aimed at anchoring the support elements of the primary thermally insulating barrier 14 on the insulating panels 16 of the secondary thermally insulating barrier 12. Each primary anchoring device comprises a stud, not depicted, which passes in a fluidtight manner through the secondary sealing membrane.

The primary thermally insulating barrier 14 comprises a plurality of posts 30 which extend in the thickness direction of the wall 11. The posts 30 are able to support the primary sealing membrane 15 and therefore to react the loads caused by the hydrostatic and dynamic pressures exerted on the primary sealing membrane 15 by the liquefied gas contained inside the tank. The posts 30 are aligned in rows which are parallel to the direction of the corrugations of the first series of corrugations 45a and in rows that are parallel to the direction of the corrugations of the second series of corrugations 45b.

The posts 30 each comprise an outer base, an inner base, and a rod extending between the outer base and the inner base. The outer base and the inner base may be made of metal, such as stainless steel, or of a composite material, such as a for example glass-fibre-reinforced epoxy resin. The outer base and the inner base are able to be fixed to the rod by any means and notably by adhesive bonding. According to another embodiment variant, the rod, together with the outer base and the inner base which collectively form the post 30, are produced as a single piece, for example by moulding. The posts have a tubular shape, preferably of circular cross section.

The primary sealing membrane 15 is itself obtained in a similar way to the secondary sealing membrane by assembling a plurality of corrugated metal sheets 44. The corrugated metal sheets 44 are each of substantially rectangular shape. The corrugated metal sheets 44 are, for example, made of Invar®: namely an alloy of iron and of nickel the coefficient of expansion of which is typically comprised between 1.2×10⁻⁶ and 2×10⁻⁶ K⁻¹, or from an iron alloy with a high manganese content the coefficient of expansion of which is typically of the order of 7×10⁻⁶K⁻¹. Alternatively, the corrugated metal sheets 44 may equally be made of stainless steel or of aluminium.

The corrugated metal sheets 44 are lap welded along their edges so as to ensure the fluidtightness of the primary sealing membrane 15. The primary sealing membrane 15 has corrugations 45. More particularly, it comprises a first series of corrugations 45a extending parallel to a first direction and a second series of corrugations 45b extending parallel to a second direction. The directions of the series of corrugations 45a, 45b are mutually perpendicular and are parallel or perpendicular to the rows of posts 30. Each of the series of corrugations 45a, 45b is parallel to two opposite edges of the corrugated metal sheets 44. The corrugations 45 project towards the inside of the tank, i.e. In the direction away from the load-bearing structure 23. Each corrugated metal sheet 44 comprises, between the corrugations 45, a plurality of planar zones 46.

Each planar zone 46 of the primary sealing membrane 15 is situated facing, in the thickness direction of the wall 11, a planar zone of the secondary sealing membrane 13.

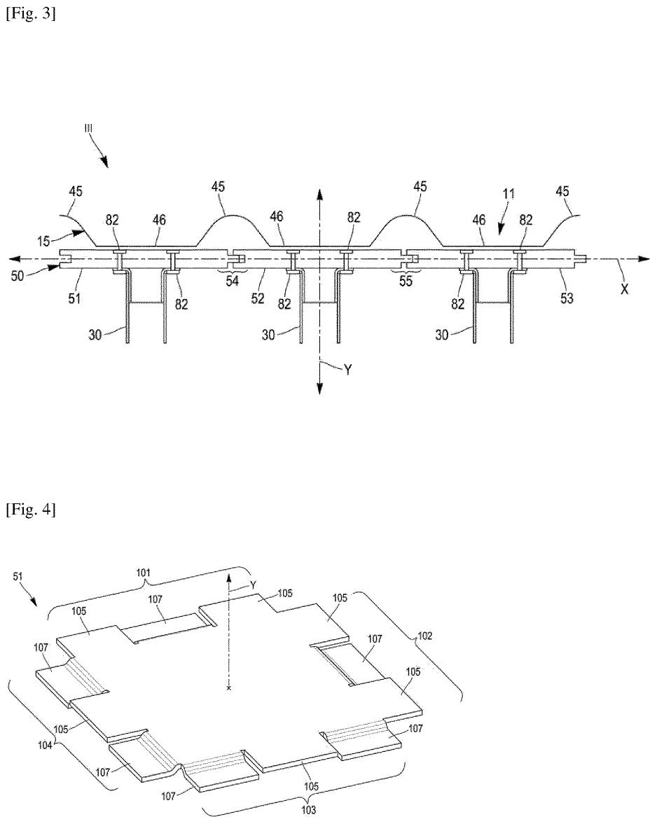

As illustrated in FIG. 3 which shows detail III of FIG. 2, the wall 11 comprises a modular structure 50 situated between a plurality of posts 30 and the primary sealing membrane 15.

The primary sealing membrane 15 is fixed on the modular structure 50 by welding at the planar zones 46. According to one embodiment, each of the planar zones 46 of the primary sealing membrane 15 is fixed on a respective sheet of the modular structure 50. According to another embodiment, the primary sealing membrane 15 is welded to the modular structure only along the edges of the corrugated metal sheets 44.

The modular structure 50 comprises a first sheet 51, a second sheet 52 and a third sheet 53. The second sheet 52 is connected to the first sheet 51 via a first connection 54 situated at a lateral portion of the first sheet 51 and a lateral portion of the second sheet 52. The second sheet is also connected via a second connection 55 to the third sheet 53 via another lateral portion of the second sheet and a lateral portion of the third sheet. The first connection 54 and the second connection 55 are such that they allow a degree of freedom in translational movement in a direction X which is perpendicular to the thickness direction of the wall and is parallel to the direction of one of the series of corrugations 45a, 45b of the primary sealing membrane 15.

The modular structure 50 is fixed to the posts 30 using threaded fasteners. What that means is that each plate is respectively fixed to a post 30 for example using a screw-nut system 82.

A sheet according to the embodiment of FIG. 3 is illustrated in greater detail in FIG. 4. For the sake of understanding, the sheet in FIG. 4 is referred to as first sheet 51. Nevertheless, the second sheet 52 and the third sheet 53 of FIG. 3 have identical characteristics.

The first sheet 51 has the overall shape of a square having a first lateral portion 101, a second lateral portion 102, a third lateral portion 103 which is opposite the first lateral portion 101, and a fourth lateral portion 104.

The first lateral portion 101 and the second lateral portion 102 each have a first rectilinear tab 105, a second rectilinear tab 105 and an outer tab 107 which is situated between the first rectilinear tab 105 and the second rectilinear tab 105.

The third lateral portion 103 and the fourth lateral portion 104 each have a rectilinear tab 105 situated between a first outer tab 107 and a second outer tab 107.

The outer tabs 107 are each offset in a thickness direction Y of the wall, towards the outside of the tank, relative to the rectilinear tabs 105.

The first lateral portion 101 and the second lateral portion 102 complement the third lateral portion 103 and the fourth lateral portion 104.

Thus, the first lateral portion 101 and the second lateral portion 102 may each be connected with either one of the third lateral portion 103 or fourth lateral portion 104 of a neighbouring sheet.

Such a first sheet 51 is manufactured for example by stamping or bending a piece of sheet metal.

By virtue of these features, the modular structure 50 allows uniform distribution of the loads applied to the posts 30 and also allows support of the primary sealing membrane 15 to be maintained in the event of damage to a post 30.

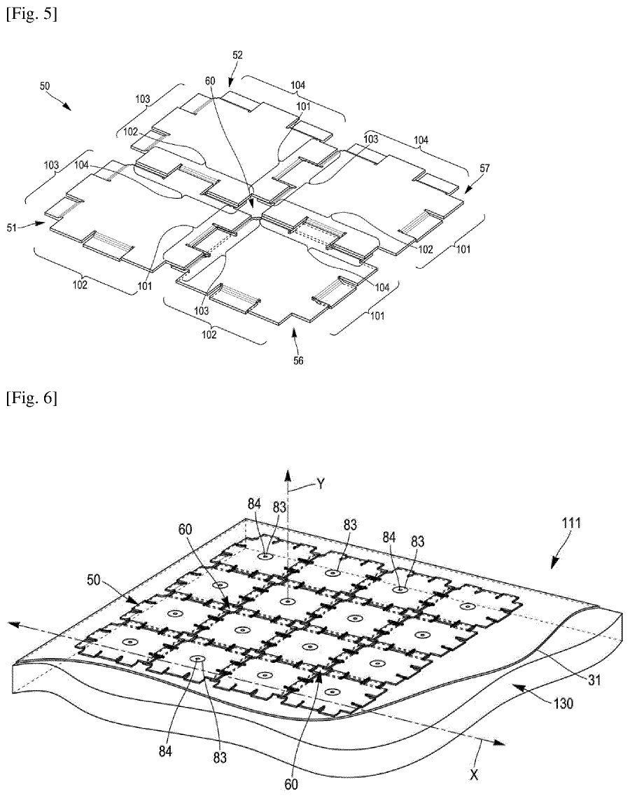

Such a modular structure 50 comprising a plurality of sheets identical to the first sheet 51 is notably illustrated in FIGS. 5 and 6.

FIG. 5 shows a modular structure 50 comprising four sheets. The modular structure 50 comprises:
a first sheet 51 connected to a second sheet 52 by contact between the fourth lateral portion 104 of the first sheet 51 and the second lateral portion 102 of the second sheet 52. The first sheet 51 also being connected to a third sheet 56 by contact between the first lateral portion 101 of the first sheet 51 and the third lateral portion 103 of the third sheet 56.
a fourth sheet 57 connected to the second sheet 52 by contact between the third lateral portion 103 of the fourth sheet 57 and the first lateral portion 101 of the second sheet 52. The fourth sheet 57 also being connected to a third sheet 56 by contact between the second lateral portion 102 of the fourth sheet 57 and the fourth lateral portion 104 of the third sheet 56.

It may be seen that there is a hole 60 at the centre of the first, second, third and fourth sheets of FIG. 5. The purpose of this hole 60 is to avoid a superposed build-up of material that might lead to difficulties with assembling the modular structure.

The above-mentioned features of this modular structure and notably of the lateral portions of the sheets allow a significant number of sheets to be assembled thus forming a modular structure of dimensions suited to the dimensions desired. The sheets collaborate with one another via the connections.

According to an embodiment variant depicted in FIG. 6, the wall 111 for a sealed and thermally insulating tank for storing a liquefied gas comprises a support element 130 which may be:
a thermally insulating panel comprising a layer of self-supporting insulating polymer foam sandwiched between an inner sheet of plywood and an outer sheet of plywood; or
an insulating box structure filled with a thermally insulating packing.

The support element further comprises a layer of flexible material 31 positioned against the panel or against the insulating box structure 130, the modular structure 50 being positioned and fixed against the layer of flexible material 31.

In this embodiment, each sheet at its centre has a circular recess 83 comprising a through-orifice 84 intended to accept a fixing. The fixing for immobilizing each sheet in the thickness direction Y of the wall 111 is performed at a single point, for example at the centre of the sheet, for example using threaded fasteners.

In a similar way to the above-mentioned embodiments, the sheets of the modular structure 50 collaborate with one another via the connections at the lateral portions that allow movement in the direction X perpendicular to the thickness direction of the wall 111. What that means to say is that when the sealing membrane (not depicted in FIG. 6) contracts or expands in response to the thermal stresses, the sheets of the modular structure 50 are each free to slide translationally in the direction X.

Furthermore, when localized loads are applied in the thickness direction Y of the wall, for example in the form of the pressures exerted by the liquid contained in the tank, said loads are passed on to the modular structure 50 and notably to the plurality of sheets that make up the modular structure 50. Furthermore, the layer of flexible material 31 increases the load-spreading effect.

By virtue of these features, in the case of a thermally insulating panel, the loads of a localized impact are spread over a larger area. This then results in a reduction in the maximum value of the stress exerted on the thermally insulating panel. It is therefore possible for example to replace a 250 kg/m³ foam with a foam of a lower density, for example 170 kg/m³, leading to a significant saving on material and therefore on cost and improved thermal behaviour of the insulating panel.

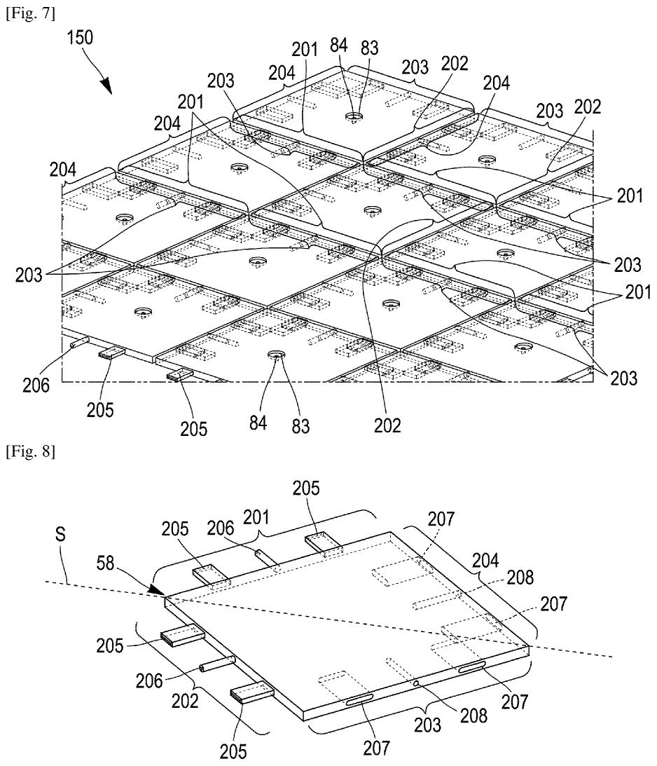

Another embodiment variant for a modular structure 150 is now discussed in connection with FIGS. 7 to 9.

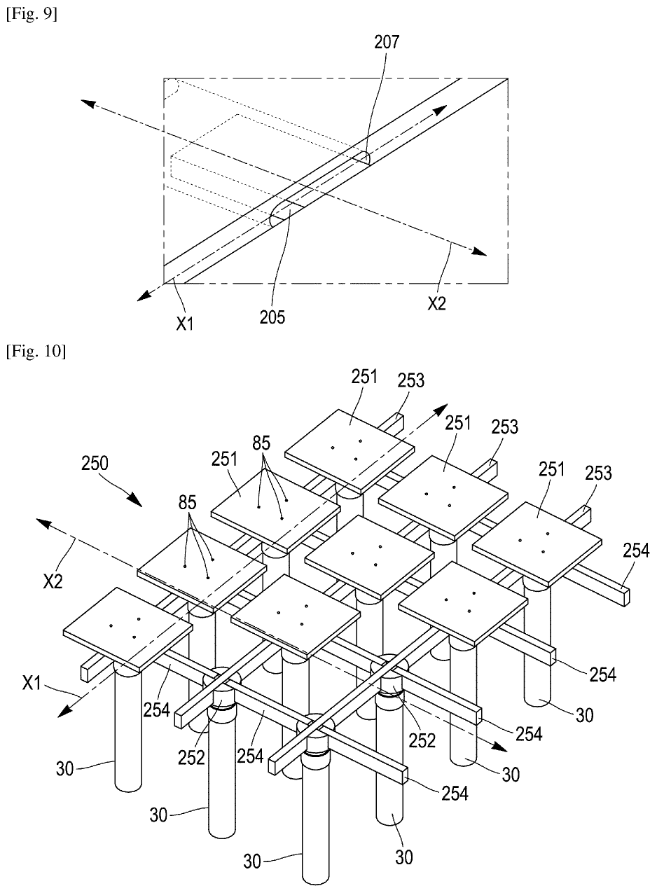

Unlike in the embodiment described above, the modular structure 150 comprises a plurality of sheets joined together via a tenon-mortise system illustrated in greater detail in FIGS. 8 and 9.

The sheet 58 of FIG. 8 has, in a way similar to the sheet 51 of FIG. 4, the overall shape of a square having a first lateral portion 201, a second lateral portion 202, a third lateral portion 203 which is opposite the first lateral portion 201, and a fourth lateral portion 204. The sheet 58 exhibits symmetry about the axis S that passes along the diagonal of said sheet 58.

The first lateral portion 201 and the second lateral portion 202 each have a first and a second rectangular tenon 205 and a cylindrical tenon 206, these projecting respectively from the first lateral portion 201 of the sheet 58 and from the second lateral portion 202 of the sheet 58.

The third lateral portion 203 and the fourth lateral portion 204 each have a first and a second rectangular mortise 207 and a cylindrical mortise 208, hollowed respectively into the third lateral portion 203 of the sheet 58 and into the fourth lateral portion 204 of the sheet 58. The dimensions of the mortises are tailored to allow them to accept the corresponding tenons.

According to the embodiment depicted in FIG. 7, each sheet of the modular structure 150 exhibits the characteristics of the sheet 58.

Thus, the first lateral portion 201 and the second lateral portion 202 may each be connected with either one of the third lateral portion 203 or fourth lateral portion 204 of a neighbouring sheet.

In FIG. 7, for each sheet, the first and second rectangular tenons 205 and the cylindrical tenon 206 of the first lateral portion 201 are respectively connected to the first and second rectangular mortises 207 and to the cylindrical mortise 208 of the third lateral portion 203 of the adjacent sheet.

Similarly, the second lateral portion 202 is connected to the fourth lateral portion 204 of the adjacent sheet via the first and second rectangular tenons 205 and the cylindrical tenon 206 of the second lateral portion 201 which are pushed into the first and second rectangular mortises 207 and into the cylindrical mortise 208 of the fourth lateral portion 203 of the adjacent sheet.

An enlargement of a connection of the first rectangular tenon 205 with the first mortise 207 of FIG. 7 is illustrated in FIG. 9. The widthwise dimensions of the first tenon 205 are less than the widthwise dimensions of the first mortise 207 so as to allow the first tenon 205 to move in the first mortise 207 in the directions X1 and X2 that are perpendicular to the thickness direction of the wall. This difference in dimensions notably makes it possible to allow a sliding movement in response to a thermal contraction or expansion, without completely breaking the connection. What that means to say is that the dimensions are also chosen with regard to the estimated thermal contraction and expansion so that the tenon does not come out of the mortise completely.

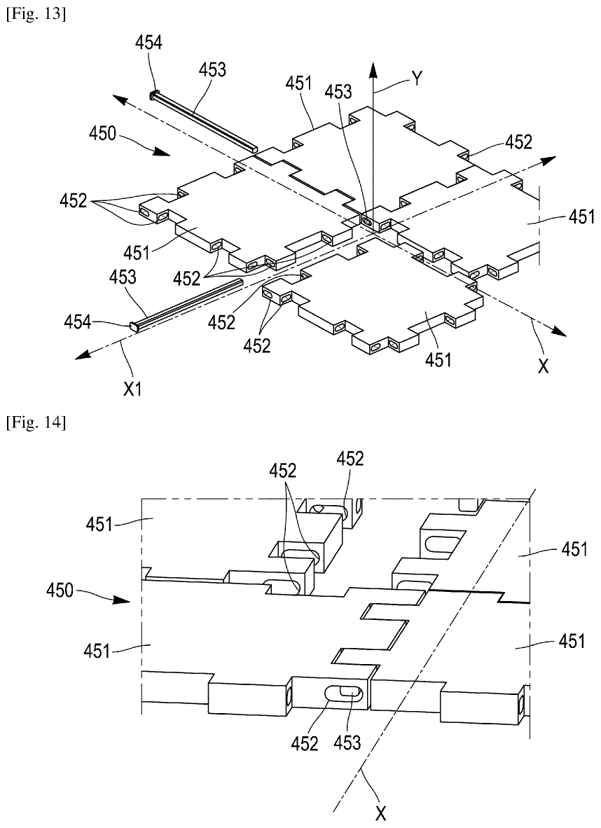

Unlike in the embodiment described above, the modular structure 450 comprises a plurality of sheets 451 joined together via an interlocking system illustrated in FIGS. 13 and 14.

This embodiment differs from the previous embodiment in that the modular structure 450 comprises a plurality of sheets 451, four of which are illustrated in FIG. 13, which are interlocked through the complementing nature of the shapes of a lateral portion of one sheet 451 and a lateral portion of another, adjacent, sheet 451. The complementing nature of the shapes of the two interlocked sheets 451 involve each sheet having openings 452 that extend in a direction X perpendicular to the thickness direction of the wall, the openings 452 forming a through-passage intended to receive a straight rod 453. The openings 452 have for example an oblong shape.

A straight rod 453 is housed in the consecutive through-openings 452 and passes through said consecutive through-openings 452 so as to maintain a degree of connection in the thickness direction Y of the wall of the interlocked sheets. The transverse dimension of the straight rod 453, measured perpendicular to the thickness direction, is less than the corresponding transverse dimension of said through-openings 452. In other words, the straight rod 453 is mounted with clearance in the transverse direction perpendicular to the longitudinal direction of the straight rod 453 and to the thickness direction Y of the wall, thereby allowing the sheets to move relative to one another in the plane orthogonal to the thickness direction of the wall.

The straight rod 453 at one end has an abutment surface in the form of a base 454 so as to keep the straight rod 453 housed in the through-passage.

FIG. 10 illustrates another embodiment of a modular structure 250. The posts 30 of FIG. 10 are organized in rows, in a similar way to the posts 30 shown in FIG. 2.

This embodiment differs from the preceding embodiments in that the modular structure 250 comprises a plurality of sheets 251 connected to one another by metal girders able to slide in one of the directions X1, X2 that are perpendicular to the thickness direction of the wall parallel to one of the series of corrugations of the series of corrugations 45a, 45b of the primary sealing membrane 15.

To achieve this, the modular structure 250 further comprises a plurality of sleeves 252 which are each positioned on an inner end of a post 30. Each sleeve 252 has two through-openings, forming a cross-shaped slot.

A plurality of continuous metal girders 253 each pass through a series of sleeves 252 that are aligned via their respective slot, in a first direction X1 perpendicular to the thickness direction of the wall. FIG. 10 notably shows three mutually parallel continuous metal girders 253 each passing through at least four aligned sleeves. The continuous metal girders 253 are capable of effecting a sliding movement in the first direction X1.

A plurality of discontinuous metal girders 254 each connect, in a second direction X2 which is perpendicular to the thickness direction of the wall and perpendicular to the first direction X1, a first sleeve 252 of a first post 30 to a second sleeve 252 of a second post 30 adjacent to the first post 30, via their respective slot. The discontinuous metal girders 254 are capable of effecting a sliding movement in the second direction X2.

Each sheet 251 is fixed, for example by means of rivets 85, to a post 30 via a sleeve 252.

In a similar way to FIG. 2, the modular structure 250 also allows uniform distribution of the loads applied to the posts 30 and also allows support of the primary sealing membrane to be maintained in the event of damage to a post 30.

According to a variant (not depicted) of the embodiment of FIG. 10, the load-bearing element is an insulating panel rather than the posts 30 and the sleeves 252 are distributed over an inner surface of the insulating panel and the continuous and discontinuous metal girders are distributed in a similar way to FIG. 10.

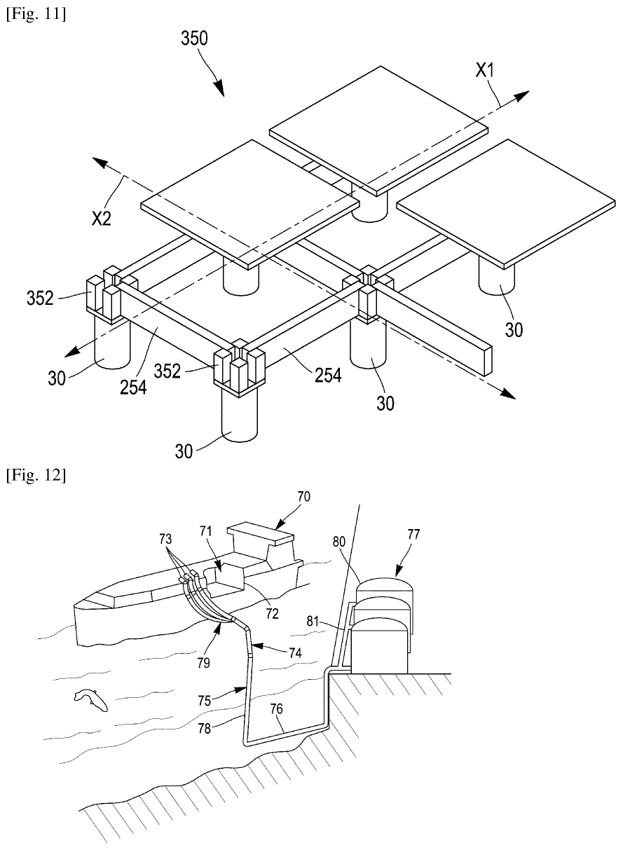

FIG. 11 shows another variant embodiment of a wall for a sealed and thermally insulating tank for storing a liquefied gas. The modular structure 350 can be differentiated from the modular structure 250 of FIG. 10 in that it comprises sleeves 352 of cubic shape and in that it comprises a plurality of discontinuous metal girders 254 in a first direction X1 and in the second direction X2 which connect two adjacent sleeves 352.

According to a variant (not depicted) of the embodiment of FIG. 11, the load-bearing element is an insulating panel rather than the posts 30 and the sleeves 352 are distributed over an inner surface of the insulating panel and the discontinuous metal girders are distributed in a similar way to FIG. 11.

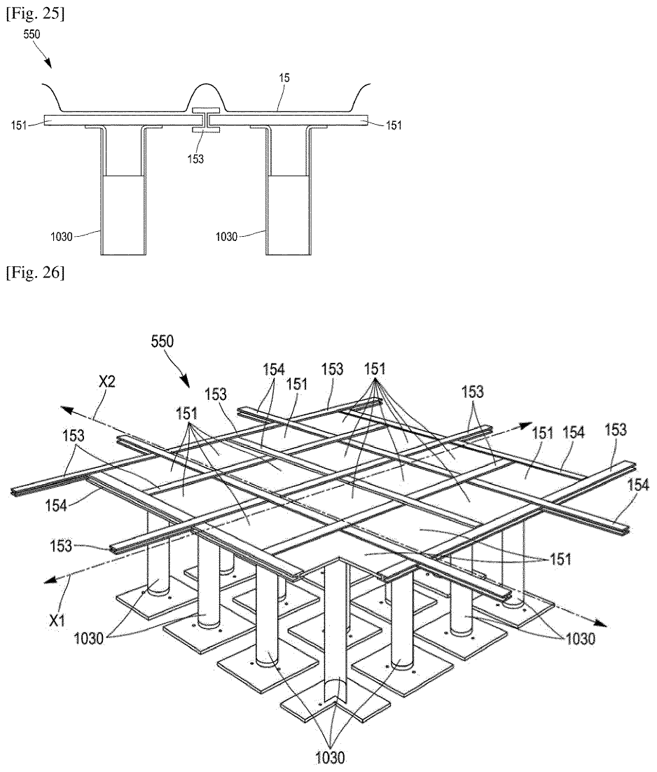

FIGS. 25 and 26 show another variant embodiment of a wall for a sealed and thermally insulating tank for storing a liquefied gas.

The modular structure 550 can be differentiated from the modular structure 250 of FIG. 10 in that the metal girders 153, 154 are positioned at the gap between two adjacent sheets 151, for example in a gap along the two sheets on each side of the gap, as illustrated in FIG. 26. FIG. 25 notably illustrates a cross-sectional view of a metal girder 153 situated facing a corrugation of the sealing membrane 15.

The metal girders 153, 154 are I-shaped with two channels each accepting at least a lateral portion of a sheet 151. The metal girders 153 extend in the first direction X1 perpendicular to the thickness direction of the wall. The metal girders 154 extend in a second direction X2 which is perpendicular to the thickness direction of the wall and perpendicular to the first direction X1.

The metal girders 153 and 154 form a network of metal girders able to block the rotation of the adjacent plates and therefore maintain the flatness and stiffness of the modular structure 550.

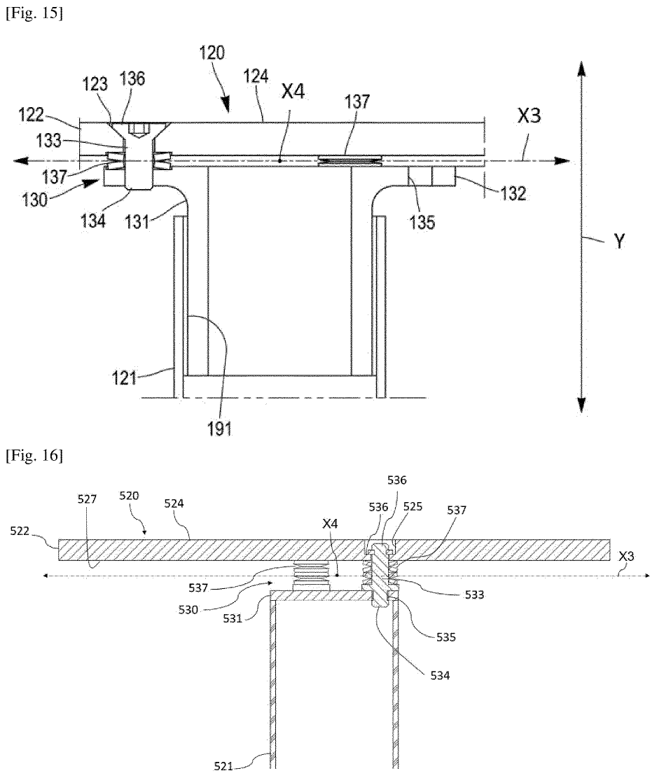

FIGS. 15 to 24 depict embodiments of the connecting device that connects the modular structure to the post. In these embodiments, the connection between the first sheet and the second sheet has been deliberately omitted in order to make the illustrations easier to understand. Elements in FIGS. 15 to 24 that are identical or similar bear the same reference numerals but incremented by a multiple of 100. It should be noted that, while these figures depict a connecting device for connecting the modular structure to a single post, an identical connecting device is advantageously used for several or all of the other posts.

A first variant of a first embodiment of the connecting device that connects the modular structure to the post is described hereinbelow with reference to FIG. 15.

The support element 120 comprises a post 121 which is hollow, a first sheet 122 and a connecting device 130 for connecting the first sheet 122 to the inner end of the post 121.

The connecting device 130 comprises a support 131 which is a metal sleeve push-fitted into the inner end of the post 121 and bonded with a coat of adhesive 191 against an inner longitudinal surface of the post 121. The sleeve extends beyond the inner end of the post 121 to form a receiving flange 132 that has a diameter greater than the outside diameter of the post 121.

The connecting device 130 comprises three threaded rods 133, referred to in the remainder of the description as screws, and only one of which can be seen in the plane of section of FIG. 15. The three screws 133 are uniformly positioned on a geometric circle that is concentric with the longitudinal axis of the post 121. In other words, the three screws 133 are distributed in such a way that the three segments of straight lines connecting the screw shanks pairwise form an equilateral triangle. The screws 133 pass through the first sheet 122 and each have an inner end 134 screwed into a tapped hole 135 which is positioned in the receiving flange 132. The screws 133 further comprise, at the inner end 136, a screw head which is positioned in a countersink 123 formed in the inner surface 124 of the first sheet 122.

The connecting device 130 further comprises an elastic member 137, which is a spring washer also known as an elastic washer or Belleville washer.

The elastic member 137 is mounted on the screw 133 between the first sheet 122 and the receiving flange 132 so as to press the first sheet 122 against the screw head 136.

When load is applied to the primary sealing membrane which is welded to the first sheet 122, the elastic-compression properties of the elastic member 137 allow the first sheet 122 to move in rotation about a first axis X3 which is perpendicular to the thickness direction of the wall and about a second axis X4 which is perpendicular to the thickness direction Y of the wall and orthogonal to the first axis X3. When the transverse loads are no longer applied to the first sheet 122, the elastic member 137 returns to its initial shape and the first sheet 122 returns to its initial position.

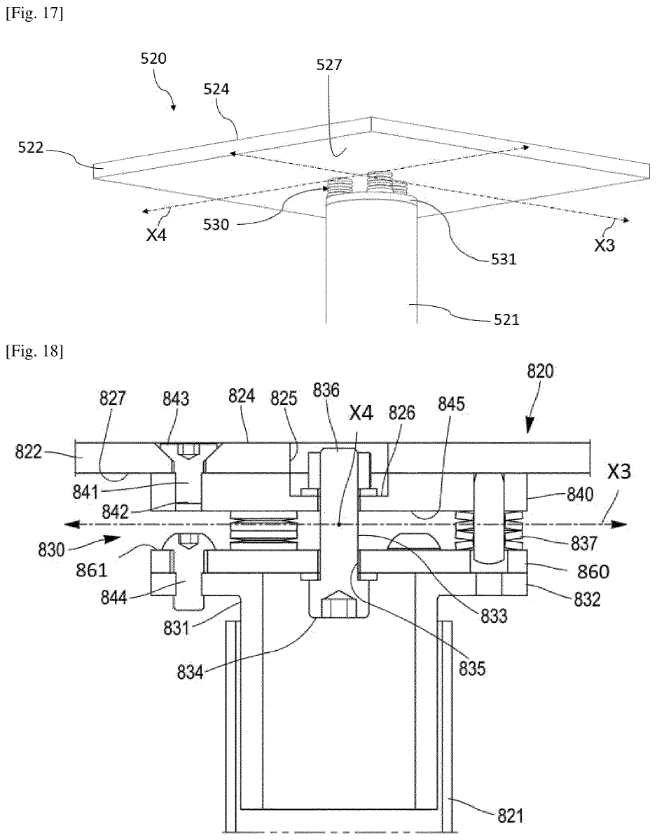

When loads are applied parallel to the thickness direction Y and uniformly to the first sheet 122, the elastic properties of the elastic member 137 allow the first sheet 122 a translational movement in the thickness direction Y of the wall. Such a movement brings the first sheet 122 closer to the fixing flange 132, reducing the distance between the first sheet 122 and the fixing flange 132 by a distance that is less than or equal to the distance represented by the capacity for elastic compression of the elastic member 137. When loads are no longer applied, the elastic member 137 returns to its initial shape and the first sheet 122 to its initial position. A second variant of the first embodiment of the connecting device that connects the modular structure to the post is described hereinbelow with reference to FIGS. 16 and 17.

The support element 520 differs from that of FIG. 15 in that the support 531 is a blanking plate, for example made of metal, which covers the opening of the hollow post 521. The blanking plate has a diameter similar or identical to the diameter of the post 521.

The support element 520 has three rods 533, just one of which is visible in the plane of section of FIG. 16, the rods 533 each passing through the first sheet 522 and each having an outer end 534 fixed in a hole 535 formed in the blanking plate and an inner end 536 fixed in a counterbore 525 having a bottom 526. The fixing of the rods 533 to the support 531 is achieved for example using a screw-thread/tapped-thread system. The screws 533 can be adjusted in the extent to which they are screwed into the tapped hole 535 so as to adjust the height of the first sheet 522.

The connecting device 530 comprises four stacked Belleville spring washers 537 mounted on each rod 533, between the first sheet 522 and the blanking plate.

The three rods 533 are distributed at the periphery of the blanking plate 531 in such a way that the three segments of straight lines connecting the rods pairwise form an equilateral triangle.

A third variant of the first embodiment of the connecting device that connects the modular structure to the post is described hereinbelow with reference to FIG. 18.

The support element 820 differs from FIG. 15 in that it comprises a first metal component 840 positioned against the outer surface 827 of the first sheet 822 and fixed against the outer surface 827 via fixing screws 841. The support element 820 further comprises a second metal component 860 situated facing the first metal component 840. The second metal component 860 is positioned against the inner surface of the receiving flange 832 and fixed against the receiving flange 832 via fixing screws 844.

The support element comprises a central threaded rod 833 which passes through the hole 835 formed in the second metal component 860. The threaded rod 833 has an outer end 834 which is fixed via an abutment surface against an outer surface of the second metal component 860 in the region of the hole 835. The threaded rod further comprises an inner end 836 fixed via an abutment surface in a counterbore 825 having a bottom 826 situated in the first metal component 840. The fixing of the rod 833 to the first metal component 840 and to the second metal component 860 is achieved for example using a screw-nut system. Optionally, the Belleville spring washers 837 may be regulated, for example preloaded, by tightening or loosening the nuts mounted on the rod 833.

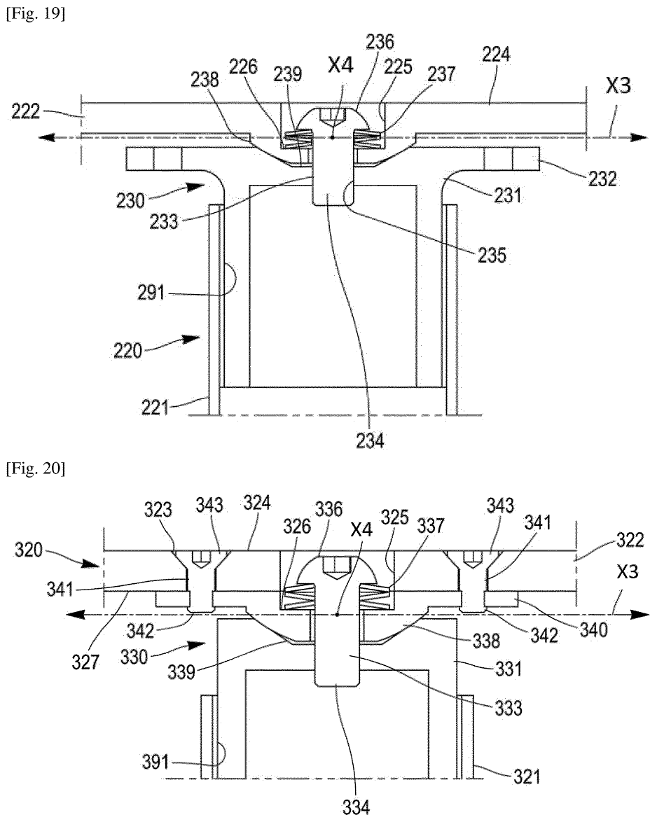

A first variant of a second embodiment of the connecting device that connects the modular structure to the post is described hereinbelow with reference to FIG. 19.

The support element 220 differs from that of FIG. 15 in that the connecting device 230 comprises a ball-joint ball element 238 housed in a ball-joint ball seat 239. The ball seat 239 is formed in the receiving flange 232 at the centre of the diameter of the receiving flange 232. The ball element 238 is formed by a protuberance projecting from the first sheet 222 and has a shape that complements that of the ball seat 239.

The connecting device 230 comprises a screw 233 which passes through the first sheet 222, the ball element 238 and the ball seat 239. The outer end 234 of the screw 233 is fixed in a hole 235 formed in the ball seat 239, and the inner end of the screw 233 comprises a screw head 236 which is positioned in a counterbore 225 formed in the inner surface 224 of the first sheet 222, the counterbore 225 having a bottom 226. The elastic member 237 is situated in the counterbore 225 between the screw head 233 and the bottom 226 of the counterbore 225 so as to press the first sheet 222 against the receiving flange 232 while at the same time permitting a degree of freedom to rotate about the first axis X3 and a degree of freedom to rotate about the second axis X4.

A second variant of the second embodiment of the connecting device that connects the modular structure to the post is described hereinbelow with reference to FIG. 20.

The support element 320 differs from that of FIG. 19 in that the metal sleeve 331 has no receiving flange and in that the ball element 338 projects from a metal component 340 positioned against the outer surface 327 of the first sheet 322. The metal component 340 has a diameter greater than the outside diameter of the post 321.

The metal component 340 is fixed to the first sheet 322 via fixing screws 341 situated at the periphery of the metal component 340. The fixing screws 341 pass through the first sheet 322 and the metal component 340. The fixing screws 341 each comprise an outer end 342 which is fixed to the metal component 340, for example by riveting, and an inner end 343 which comprises a screw head which is housed in a countersink 323 formed in the inner surface 324 of the first sheet 322.

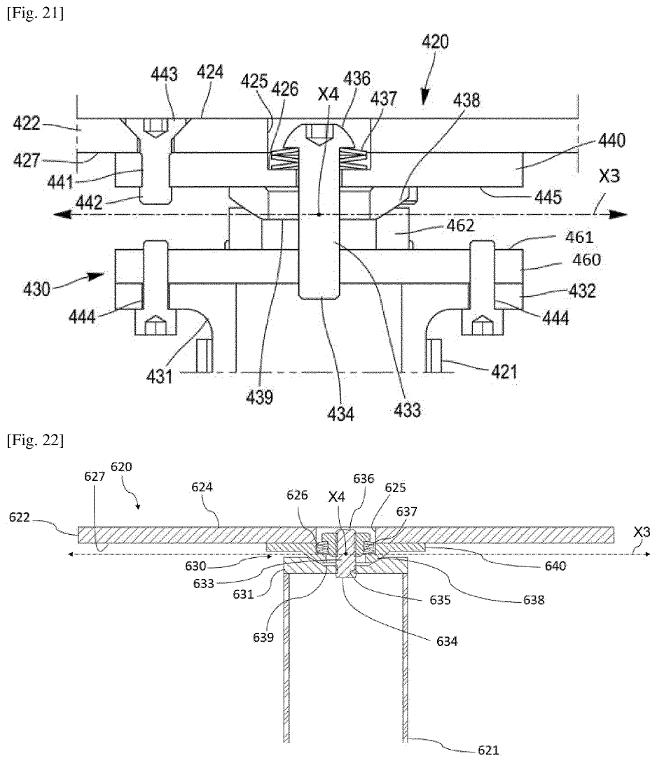

A third variant of the second embodiment of the connecting device that connects the modular structure to the post is described hereinbelow with reference to FIG. 21.

The support element 420 differs from that of FIG. 19 in that it comprises a first metal component 440 positioned against the outer surface 427 of the first sheet 422 and fixed against the outer surface 427 via fixing screws 441. The support element 420 further comprises a second metal component 460 situated facing the first metal component 440. The second metal component 460 is positioned against the inner surface of the receiving flange 432 and fixed against the receiving flange 432 via fixing screws 444.

The first metal component 440 comprises a ball element 438 forming a protuberance projecting from the outer surface 445, and the second metal component 460 comprises a base 462 projecting from the inner surface 461 of the second metal component 460, the base comprising the ball seat 439. The ball element 438 is housed in the ball seat 439.

The first metal component 440, the second metal component 460 and the receiving flange 432 have for example identical or similar diameters.

The screw 433 passes through the first sheet 422, the first metal component 440, the ball element 438, the ball seat 439 and the second metal component 460. The screw 433 has an outer end which is fixed in the second metal component 460.

According to a variant of the embodiment of FIG. 21, the elastic member 437 is replaced by a spherical washer situated in the counterbore 425 between the screw head 436 and the bottom 426 of the counterbore 425. The spherical washer has two parts which collaborate with one another via spherical surfaces, giving the screw head 436 mobility with respect to the first sheet 422.

A fourth variant of the second embodiment of the connecting device that connects the modular structure to the post is described hereinbelow with reference to FIG. 22.

The support element 620 differs from that of FIG. 20 in that the support is a blanking plate 631. The ball seat 639 is formed in the blanking plate 632 at the centre of the diameter of the blanking plate 632.

The fixing rod 633 passes through the first sheet 622, the metal component 640 and the blanking plate 632.

The rod 633 has an outer end 634 fixed in a hole 635 formed at the centre of the diameter of the blanking plate 632, and an inner end fixed via a rod head 636 in the counterbore 625 formed in the first sheet 622.

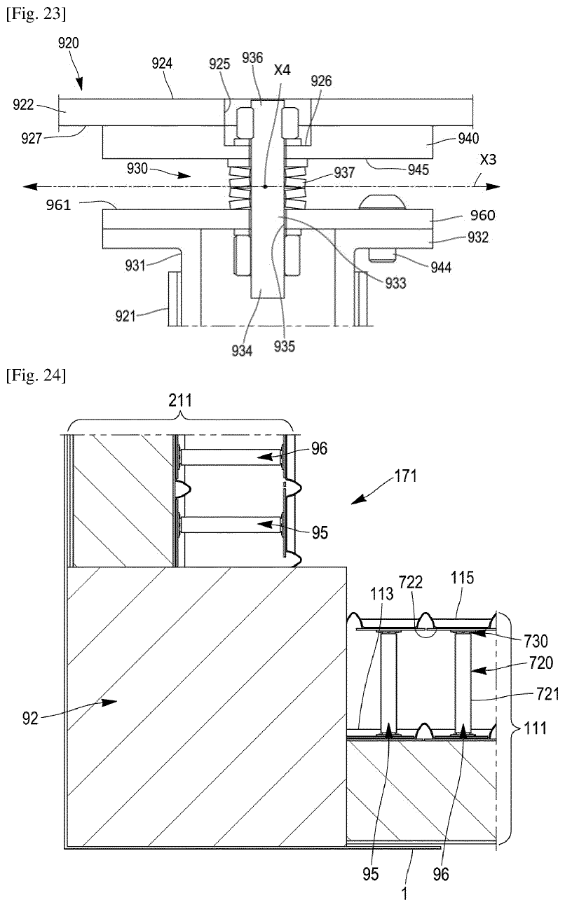

A third embodiment is described hereinbelow with reference to FIG. 23.

The support element 920 differs from that of FIG. 21 in that it does not have the ball element 438 or the base 452 illustrated in FIG. 21, and in that the elastic member 837 is positioned between the first metal component 940 and the second metal component 960.

The fixing of the threaded rod 933 to the first metal component 940 and to the second metal component 960 is for example achieved in a similar way to the embodiment illustrated via FIG. 18, namely via screw-nut systems.

The various embodiments of the connecting device which have been illustrated in connection with FIGS. 15 to 23 can be applied to the tank walls of FIGS. 2 to 11. For example, the threaded fasteners comprising nuts 82 illustrated in FIG. 3 may be replaced by a connecting device from the embodiments illustrated in FIGS. 15 to 23.

The above-mentioned wall 11, comprising one or more aforementioned load-bearing elements, is intended to be integrated into a sealed and thermally insulating tank for storing a liquefied gas. The liquefied gas intended to be stored in the tank may notably be liquid hydrogen which has the particular feature of being stored at approximately −253° C. at atmospheric pressure.

Such a tank is fixed against a load-bearing structure 1 as illustrated in FIG. 1.

FIG. 24 illustrates a corner 171 of a sealed and thermally insulating tank for storing a liquefied gas. The tank comprises a first tank wall 111 and a second tank wall 211 forming a corner of the tank, the first and second walls 111, 211 being connected in a connecting zone 92. The first and second tank walls may have the above-mentioned characteristics.

The secondary sealing membrane 113 of the first tank wall 111 is connected to the secondary sealing membrane of the second tank wall 211 in the connecting zone 92.

The primary sealing membrane 115 of the first tank wall 111 is connected to the primary sealing membrane of the second tank wall 211 in the connecting zone 92.

The first tank wall 111 and the second tank wall 211 each comprise, at the primary thermally insulating barrier, a first row 95 of support elements supporting the primary sealing membrane and which extends parallel to the corner edge formed at the intersection between the first and second walls, and the support elements of which extend in the thickness direction of their respective wall, between the secondary sealing membrane 113 and the primary sealing membrane 115.

The first tank wall 111 and the second tank wall 211 furthermore each comprise, at the primary thermally insulating barrier, a second row 96 of support elements, parallel to the first row, and the support elements of which likewise extend in the thickness direction of their respective wall. The support elements of each second row 96 comprise load-bearing elements 720 which for example have the characteristics of a support element as illustrated in one of FIGS. 1 to 23.

With reference to FIG. 12, a cut-away view of a ship 70 for transporting a liquefied gas shows a sealed and thermally insulating tank 71 with a prismatic overall shape mounted inside the double hull 72 of the ship. The wall of the tank 71 comprises a primary sealing membrane intended to be in contact with the liquefied gas, for example LNG, contained in the tank, a secondary sealing membrane arranged between the primary sealing membrane and the double hull 72 of the ship, and two thermally insulating barriers arranged between the primary sealing membrane and the secondary sealing membrane and between the secondary sealing membrane and the double hull 72, respectively.

In a manner known per se, loading/offloading pipelines 73 arranged on the upper deck of the ship can be connected, by means of appropriate connectors, to a maritime or harbour terminal in order to transfer a cargo of LNG from or to the tank 71.

FIG. 12 shows an example of a maritime terminal having a loading and offloading station 75, an underwater pipe 76 and an onshore facility 77. The loading and offloading station 75 is a fixed offshore facility comprising a mobile arm 74 and a tower 78 that supports the mobile arm 74. The mobile arm 74 carries a bundle of insulated hoses 79 that can connect to the loading/offloading pipes 73. The orientable mobile arm 74 adapts to suit all sizes of ship 70. A connecting line (not shown) extends inside the tower 78. The loading and offloading station 75 allows the ship 70 to be loaded and offloaded from or to the onshore facility 77. This facility has liquefied gas storage tanks 80 and connecting lines 81 connected via the underwater pipe 76 to the loading/offloading station 75. The underwater pipe 76 makes it possible to transfer the liquefied gas between the loading or offloading station 75 and the onshore facility 77 over a long distance, for example 5 km, allowing the ship 70 to be kept standing offshore by a long distance during the loading and offloading operations.

In order to generate the pressure needed for transferring the liquefied gas, use is made of the pumps carried on board the ship 70 and/or of the pumps with which the onshore facility 77 is equipped and/or of the pumps with which the loading and offloading station 75 is equipped.

Although the invention has been described in connection with several particular embodiments, it is quite obvious that it is in no way limited thereto and that it comprises all the technical equivalents of the means described and also their combinations, if these come within the scope of the invention.

Use of the verb “comprise” or “include” or “have”, including when conjugated, does not exclude the presence of other elements or other steps in addition to those mentioned in a claim.

In the claims, reference signs between parentheses should not be understood to constitute a limitation to the claim.

1. A wall for a sealed and thermally insulating tank for storing a liquefied gas, the wall comprising in succession, in a thickness direction of the wall;
a thermally insulating barrier configured to be anchored on a load-bearing structure; and
a sealing membrane which rests against the thermally insulating barrier, the sealing membrane being a corrugated sealing membrane comprising a first series of corrugations having first corrugations parallel to one another and a second series of corrugations having second corrugations parallel to one another and perpendicular to the first corrugations the sealing membrane comprising a plurality of planar zones each of which is defined between two adjacent first corrugations and between two adjacent second corrugations;
wherein the thermally insulating barrier comprises:
at least one support element; and
a modular structure situated between the at least one support element and the sealing membrane, the modular structure being fixed against the at least one support element, the sealing membrane resting against the modular structure and being fixed to said modular structure, the modular structure comprising at least a first sheet and a second sheet, the sealing membrane comprising a first zone fixed to the first sheet and a second zone fixed to the second sheet, the first zone and the second zone corresponding to two adjacent planar zones, the first sheet being connected to the second sheet by a connection which offers a degree of freedom in translation in a direction perpendicular to the thickness direction of the wall and a degree of connection in the thickness direction of the wall.

2. The wall according to claim 1, wherein the connection is formed by direct contact between a lateral portion of the first sheet and a lateral portion of the second sheet.

3. The wall according to claim 2, wherein the lateral portion of the first sheet comprises at least a first straight tab and an external tab the tabs respectively being situated one on each side, in the thickness direction of the wall of a respective portion of the lateral wall of the second sheet.

4. The wall according to claim 3, wherein the lateral portion of the first sheet comprises a second straight tab, the external tab being positioned between the first and second straight tabs and the lateral portion of the second sheet comprises a first external tab, a second external tab and a straight tab positioned between the first external tab and the second external tab of the lateral portion of the second sheet, the first and second straight tabs of the lateral portion of the first sheet extending in a rectilinear fashion and the first and second external tabs of the lateral portion of the second sheet being offset in the thickness direction of the wall and positioned respectively on an outside of the straight tab of the lateral portion of the second sheet, the straight tab of the lateral portion of the second sheet extending in a rectilinear fashion and the external tab of the lateral portion of the first sheet being offset in the thickness direction of the wall and positioned on the outside of the straight tab of the lateral portion of the second sheet.

5. The wall according to claim 2, wherein the lateral portion of the first sheet engages through interlocking of shapes with the lateral portion of the second sheet and forms an interlock zone.

6. The wall according to claim 5, wherein the lateral portion of the first sheet comprises a tenon projecting towards the second sheet, said tenon being received in a mortise configured in the lateral portion of the second sheet.

7. The wall according to claim 5, wherein the interlock zone has a through-passage passing in the direction perpendicular to the thickness direction of the wall through the lateral portion of the first sheet and the lateral portion of the second sheet, the through-passage being formed by at least one opening formed in the lateral portion of the first sheet and corresponding with at least one opening formed in the lateral portion of the second sheet, wherein a rod is housed in said through-passage so that the first sheet and the second sheet have a degree of connection in the thickness direction of the wall.

8. The wall according to claim 1, wherein the modular structure comprises a third sheet, a fourth sheet and a fifth sheet, the sealing membrane comprising a third zone fixed to the third sheet, a fourth zone fixed to the fourth sheet and a fifth zone fixed to the fifth sheet, the first sheet being connected to the third, fourth and fifth sheets by connections which offer a degree of freedom in translation in a direction perpendicular to the thickness direction of the wall and a degree of connection in the thickness direction of the wall

9. The wall according to one claim 1, wherein the first sheet is fixed against the at least one support element via a first fixing situated at a centre of the first sheet and wherein the second sheet is fixed against the at least one support element via a second fixing situated at the centre of the second sheet.

10. The wall according to claim 1, wherein the at least one support element is a thermally insulating panel comprising a layer of self-supporting insulating foam sandwiched between a rigid inner sheet and a rigid outer sheet.

11. The wall according to claim 1, wherein the at least one support element is an insulating box structure comprising a bottom sheet, a top sheet and load-bearing webs extending, in the thickness direction of the wall, between the bottom sheet and the top sheet and delimiting at least one compartment filled with a thermally insulating packing.

12. The wall according to claim 1, wherein the at least one support element comprises a layer of flexible material in contact with the modular structure.

13. The wall according to one claim 1, wherein the thermally insulating barrier comprises a first support element and a second support element, the first support element being a first post and the second support element being a second post the first post and the second post extending in the thickness direction of the wall the first post being fixed to the first sheet and the second post being fixed to the second sheet.

14. The wall according to claim 13, wherein the modular structure comprises:
a first sleeve fixed between an inner end of the first post and the first sheet,
a second sleeve fixed between an inner end of the second post and the second sheet, and
a metal girder connecting the first sleeve and the second sleeve by way of a sliding joint that slides in the direction perpendicular to the thickness direction of the wall.

15. The wall according to claim 14, wherein the thermally insulating barrier comprises a third support element, the third support element being a third post extending in the thickness direction of the wall, wherein the first post, the second post and the third post are aligned.

16. The wall according to claim 15, wherein the modular structure comprises a third sheet and a third sleeve which is fixed between an inner end of the third post and the third sheet, the sealing membrane comprising a third zone fixed to the third sheet, and wherein the metal girder connects the third sleeve.

17. The wall according to one claim 14, wherein the first sleeve and the second sleeve have a through-opening in the direction perpendicular to the thickness direction of the wall so as to receive the metal girder

18. The wall according to one claim 13, wherein the first sheet is connected to an inner end of the first post via a connecting device which holds the first sheet on the first post in the thickness direction the connecting device is configured to provide:
a degree of freedom to rotate about a first axis which is perpendicular to the thickness direction of the wall, and
a degree of freedom to rotate about a second axis which is perpendicular to the thickness direction of the wall and orthogonal to the first axis.

19. The wall according to claim 1, wherein the thermally insulating barrier is a primary thermally insulating barrier and the sealing membrane is a primary sealing membrane configured to come into contact with the liquefied gas contained in the tank, the wall comprising a secondary thermally insulating barrier configured to rest against the load-bearing structure, a secondary sealing membrane which rests against the secondary thermally insulating barrier the primary thermally insulating barrier resting against the secondary sealing membrane and the primary sealing membrane resting against the primary thermally insulating barrier.

20. The wall according to claim 1, wherein the liquefied gas is hydrogen.

21. A sealed and thermally insulating tank comprising a plurality of walls according to claim 1.

22. A ship for transporting a liquefied gas, the ship having a double hull and a sealed and thermally insulating tank according to claim 21 arranged inside the double hull.

23. A transfer system for transferring a liquefied gas, the system including a ship, insulated pipelines arranged so as to connect the sealed and thermally insulating tank installed in the double hull of the ship to a floating or on-shore storage facility, and a pump for driving a flow of liquefied gas through the insulated pipelines from or to the floating or on-shore storage facility to or from the sealed and thermally insulating tank of the ship according to claim 22.

24. A method for loading or offloading a ship according to claim 22, in which a liquefied gas is conveyed through insulated pipelines from or to a floating or on-shore storage facility to or from the sealed and thermally insulating tank of the ship.
